(19) United States
(12) Patent Application Publication
(10) Pub. No.: US 2025/0084511 A1
(43) Pub. Date: Mar. 13, 2025

(54) ENHANCED MAGNETIC PERFORMANCE OF MANGANESE ALUMINUM ALLOY VIA TITANIUM ADDITION

(71) Applicant: The Trustees of Dartmouth College, Hanover, NH (US)

(72) Inventors: Thomas Keller, Hanover, NH (US); Dylan Barbagallo, Hanover, NH (US); Geoffroy Hautier, Hanover, NH (US); Ian Baker, Hanover, NH (US); Tushar Kanti Ghosh, Louvain-la-Neuve (BE); Natalya Sheremetyeva, Hanover, NH (US)

(21) Appl. No.: 18/883,022

(22) Filed: Sep. 12, 2024

Related U.S. Application Data
(60) Provisional application No. 63/582,063, filed on Sep. 12, 2023.

(51) Int. Cl. C22C 22/00; H01F 1/047

(52) U.S. Cl. CPC C22C 22/00; H01F 1/047; C22C 2202/02

(57) ABSTRACT

A Mn—Al—Ti permanent magnet includes a body composed of an alloy consisting essentially of manganese in an amount of 50 to 56 atomic percent, aluminum in an amount of 44 to 50 atomic percent, and titanium in an amount of 0.5 to 1.5 atomic percent with a total amount of manganese, aluminum, and titanium not exceeding 100 atomic percent. In one preferred embodiment, a composition for the Mn—Al—Ti permanent magnet is Mn₅₄Al₄₅Ti₁ with substantially no other elemental additions being present. The addition of titanium in amounts of approximately 1 atomic percent to the Mn—Al system is believed to result in the titanium sitting on the anti-phase boundary (APB) sites with atoms coupling ferromagnetically across the APB in the presence of titanium, resulting in suppression of the negative effects of the APB and improving the remanence over a titanium-less Mn—Al permanent magnet. This system also exhibits sustained coercivity at high temperatures.

### CROSS-REFERENCE TO RELATED APPLICATIONS

This application claims the benefit of U.S. Provisional Patent Application No. 63/582,063 filed on Sep. 12, 2023, which is incorporated by reference for all purposes as if set forth in its entirety herein.

### STATEMENT REGARDING FEDERALLY SPONSORED RESEARCH

This invention was made with Government support under contracts 1852529 and 2032592 awarded by the National Science Foundation. The Government has certain rights in the invention.

### BACKGROUND OF THE INVENTION

### 1. Field of the Invention

This invention relates to compositions and methods of improving magnetic performance in aluminum-manganese alloys.

### 2. Description of the Related Art

Permanent magnets (PMs) are necessary components in devices such as electric motors and generators. Currently, PMs based on Nd—Fe—B and Sm—Co offer the highest performance but have a high raw material cost. The rare-earth (RE) raw materials of such permanent magnets also suffer from scarcity and require extractive mining. Manganese and aluminum are far cheaper and more abundant, but the state of the art has failed to produce a manganese-aluminum (Mn—Al) permanent magnet with similar performance to RE permanent magnets.

Accordingly, there is a need for improved compositions and method of making permanent magnets, including manganese-aluminum permanent magnets, with performance comparable to rare earth permanent magnets.

### SUMMARY OF THE INVENTION

Many of the deficiencies in current Mn—Al PMs relate to their inability to simultaneously provide acceptable levels of coercivity and remanence, as well as preventing anti-phase boundary (APB) defects that have been detrimental to performance. Disclosed herein are compositions and materials that provide Mn—Al based PMs with improved magnetic properties for use as permanent magnets. This improvement can be achieved by the limited introduction of titanium (targeted at about 1 atomic percent), which has been found to preferentially sit on the APBs and which is demonstrated herein to result in better ferromagnetic pairing across the APB. The use of titanium suppresses the normally negative effect of APBs and is shown to improve remanence in the resultant PM to levels not previously seen in isotropic Mn—Al based PMs. Additionally, the Mn—Al—Ti PMs described herein are shown to have achieved better higher temperature stability (for example, at above 550° C.) with the ability to maintain coercivity for extended periods of time. This higher temperature stability evinces the ability of these PMs to have longer performance lifetimes and enables processing or production (for example, by sintering) of the PMs at higher temperatures without loss of coercivity, which has proven to be a barrier to producing a commercially relevant Mn—Al PM product.

While titanium has been previously added to Mn—Al compositions, the titanium has been introduced in larger quantities (i.e., 2 at. % and 4 at. %). However, titanium is generally not an element known for its effect on magnetic properties, and in those cases where larger quantities of titanium were added, those amounts of titanium did not result in the magnetic improvements described and demonstrated herein at lower levels of titanium. Surprisingly and unexpectedly, as disclosed herein, the addition of approximately 0.5 to 1.5 atomic percent titanium to Mn—Al base compositions in a range of 50Mn/50Al to 56Mn/44Al (which compositional range is based on ability for the τ and ε phases to form, which can be established from a Mn—Al phase diagram) was found to result in magnetic improvements over the titanium-less Mn—Al base composition. The 0.5 to 1.5 atomic percent titanium range is centered about results of 1 atomic percent titanium additions (targeted). There is some imprecision in the amount of titanium added, and the composition is measured after samples were prepared, so surrounding range might be further optimized including potentially based on variations to the base alloy composition before titanium is added. Although some additional study remains to optimize ranges to be targeted and the results achieved, the benefits are believed achievable over the workable range of Mn—Al PM compositions to varying degrees.

According to one aspect of the disclosure, a Mn—Al—Ti permanent magnet is disclosed. The Mn—Al—Ti permanent magnet includes a body composed of an alloy. The alloy consists essentially of manganese in an amount of 50 to 56 atomic percent of the alloy, aluminum in an amount of 44 to 50 atomic percent of the alloy, and titanium in an amount of 0.5 to 1.5 atomic percent of the alloy. The total amount of manganese, aluminum and titanium does not exceed 100 atomic percent.

In some forms, some small amount of unavoidable additional elements or non-effective impurities may still be present in the composition without deviating from the intended scope of the targeted ranges.

In some forms, the alloy may be more specifically defined as a ternary alloy consisting of manganese in an amount of 50 to 56 atomic percent, aluminum in an amount of 44 to 50 atomic percent, and titanium in an amount of 0.5 to 1.5 atomic percent. Again, due to processing limitations, some small amount of unavoidable additional elements or non-effective impurities may still be present in the composition.

In some forms, in the alloy the amount of manganese may be between 53 and 55 atomic percent of the alloy, the amount of aluminum may be between 44 and 46 atomic percent of the alloy, and the amount of titanium may be between 0.5 to 1.5 atomic percent of the alloy.

In one form of the Mn—Al—Ti permanent magnet, in the alloy the amount of manganese may be 54 atomic percent of the alloy, the amount of aluminum may be 45 atomic percent of the alloy, and the amount of titanium may be 1 atomic percent of the alloy. Substantially no other elements may be present in the alloy.

In some forms, the Mn—Al—Ti permanent magnet consisting essentially of manganese, aluminum, and titanium may have a (BH)ₘₐₓ exceeding 33% of a titanium-less Mn—Al permanent magnet having 54 atomic percent manganese and 46 atomic percent aluminum.

In one form of the Mn—Al—Ti permanent magnet, in the alloy the amount of manganese is 53 atomic percent of the alloy, the amount of aluminum is 46 atomic percent of the alloy, and the amount of titanium is 1 atomic percent of the alloy with substantially no other elements present in the alloy.

In some forms of the Mn—Al—Ti permanent magnet, the amount of titanium may be between 0.75 to 1.25 atomic percent of the alloy. More narrowly, it is contemplated that the range of titanium additions to be added may be between, 0.8 and 1.2 atomic percent of the alloy, 0.9 and 1.1 atomic percent of the alloy, or 0.95 and 1.05 atomic percent of the alloy.

In some forms, the titanium preferentially may sit on anti-phase boundaries (APBs) of the microstructure, resulting in ferromagnetic coupling across the APBs, thereby suppressing negative effects usually associated with APBs in a titanium-less Mn—Al permanent magnet and improving remanence of the Mn—Al—Ti permanent magnet.

In some forms, the titanium may stabilize a coercivity of the Mn—Al—Ti permanent magnet at elevated temperatures in excess to 550° C. in comparison to a titanium-less Mn—Al permanent magnet with Mn to Al ratios to that of the Mn—Al—Ti permanent magnet. Such elevated temperatures would clearly be bounded on an upper side by the presence of PM remaining in the solid state, which can vary by precise composition.

In some forms, the addition of titanium relative to a titanium-less Mn—Al permanent magnet with Mn to Al ratios to that of the Mn—Al—Ti permanent magnet stabilizes the τ/ε phase to improve processing of the Mn—Al—Ti permanent magnet at elevated temperatures and stabilizing coercivity.

In some forms, regardless of direction of measurement, Mᵣ, H_{ci}, and (BH)ₘₐₓ may be greater in the Mn—Al—Ti permanent magnet in comparison to a titanium-less Mn—Al permanent magnet with Mn to Al ratios of the Mn—Al—Ti permanent magnet.

In some forms, in comparison to a titanium-less Mn—Al permanent magnet with Mn to Al ratios of the Mn—Al—Ti permanent magnet, the Mn—Al—Ti permanent magnet may have a decreased density of anti-phase boundaries and an increased anti-phase boundary domain size, resulting in less antiferromagnetic coupling and fewer magnetic domain reversal sites.

According to another aspect, a method of making a Mn—Al—Ti permanent magnet is disclosed. An alloy is formed in which the alloy consisting essentially of manganese in an amount of 50 to 56 atomic percent of the alloy, aluminum in an amount of 44 to 50 atomic percent of the alloy, and titanium in an amount of 0.5 to 1.5 atomic percent of the alloy. A total amount of manganese, aluminum and titanium does not exceed 100 atomic percent into a body of a Mn—Al—Ti permanent magnet.

In some forms, the step of forming the alloy into the body of a Mn—Al—Ti permanent magnet may occur as part of a casting operation in which the manganese, aluminum, and titanium are melted and then cast. In still other forms, the step of forming the alloy into the body of a Mn—Al—Ti permanent magnet may comprise sintering powder metal containing the manganese, aluminum, and titanium.

The invention and the technical environment are explained in greater detail below with reference to the appended drawings. It should be noted that the invention is not intended to be limited by the embodiments which are set out. In particular, unless otherwise explicitly set out, it is also possible to extract partial aspects of the content and features, including those of the claims, and to combine them with other components and findings or features from the present description or other claims.

These and other features, aspects, and advantages of various embodiments of the present invention will become better understood with regard to the following description, appended claims, and accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates thermal VSM measurement of Mn₅₄Al₄₆ τ phase exhibiting antiferromagnetic (AFM) behavior of increasing M with increasing T up to T_{C}.

FIG. 2 illustrates the density functional theory (DFT) supercell used to model the effects of elemental substitution on the APB. Mn atoms shown with their magnetic moment spin as an arrow and Al atoms shown without. The large arrows indicate the locations of two APBs in the supercell.

FIG. 3 illustrates the Mn substitutional site on the APB is shown in the box marking the APB (as the right most atom in the center row of the rightmost box). Other possible sites are labeled as A-G. The energy of formation approaches the bulk as the substitutional atom moves from the APB site to site D.

FIG. 4 illustrates the DFT results for the energy of formation of the APB with the ternary elements located at the APB. The more negative E^{F}[Z], the more favorable it is for the element to segregate to the APB

FIG. 5 shows the energy per atom calculated for different size N supercells of Mn—Al containing the APB defects in either the ferromagnetic (FM) or antiferromagnetic (AFM) states (see FIG. 2). The dotted line is the bulk energy per atom that the two supercell curves are expected to converge to for very large N.

FIG. 6 shows the DFT results for the energy of formation of the APB for a given ternary element in an AFM configuration compared to an FM configuration. The more positive E^{APB}[Z], the more the addition of the elements at the APB favors the FM configuration compared to the AFM configuration. The elements of Co, Cu, Fe, and Ni do not favor the APB compared to the bulk as shown in FIG. 3.

FIGS. 7A, 7B, and 7C illustrate demagnetization-corrected VSM curves of the Mn—Al—Ti alloys measured in the three orientations of the rectangular prism samples (long axis in FIG. 7A, medium axis in FIG. 7B, and short axis in FIG. 7C) to observe any effects due to crystal texture.

FIG. 8A illustrates the high-field VSM M-H and FIG. 8B illustrates dM/dH reversal curves for the Mn—Al—Ti alloys. The arrows indicate the reversal direction from high positive field to high negative field. The dM/dH data shows the crossover-point in differential χ from the alloys with Ti addition to the Mn₅₄Al₄₆ alloy at −600 kA/m.

FIG. 9 illustrates the magnetic moment of Mn—Al—Ti alloys as a function of temperature. Note the small variation in T_{C} as well as the AFM behavior shown in Mn₅₄Al₄₆ of increasing M with T.

FIG. 10 shows a schematic of magnetic moment varying with temperature for a NiO⋅Cr2O3 ferrimagnet where the superposition of AFM moment behavior and FM moment behavior results in a similar curve to that observed in Mn₅₄Al₄₆.

FIG. 11 illustrates the VSM curves measured from 25° C.-200° C. that show the temperature dependence of the magnetic properties. Values for M and (BH)ₘₐₓ are relative and not absolute because samples were not demagnetization corrected.

FIG. 12A provides EBSD τ phase inverse pole figures (IPF) for Mn₅₄Al₄₆, FIG. 12B illustrates EBSD τ phase inverse pole figures (IPF) for Mn₅₃Al₄₆Ti₁, and FIG. 12C illustrates EBSD τ phase inverse pole figures (IPF) for Mn₅₄Al₄₅Ti₁. A large increase in grain size and twinning of the samples with Ti can be observed.

FIG. 13 provides TEM BF images (upper three panels) and DF images (lower three panels) of Mn—Al—Ti alloys showing how the density of APBs decreases with Ti addition. The leftmost upper and lower panels show BF and DF images for Mn₅₄Al₄₆, respectively; the center upper and lower panels show BF and DF images for Mn₅₃Al₄₆Ti₁, respectively; and the rightmost upper and lower panels show BF and DF images for Mn₅₄Al₄₅Ti₁, respectively. B is the beam direction and g is the diffraction vector.

FIG. 14 illustrates DSC heat flow as a function of temperature at a heating rate of 10° C./min. The low-temperature exotherm is the ordering of ε phase to ε′ and the high-temperature exotherm is the transformation to τ phase.

FIG. 15 shows the variation of M_{796kA/m} and H_{ci} with respect to time for heat treatments at 450° C. and 550° C.

FIG. 16 shows H_{ci} (upper panel) and M_{796kA/m} (lower panel) for the various compositions as a function of time at 250° C. in air. Samples were not demagnetization corrected so M_{796kA/m} values are relative and not absolute.

FIG. 17 shows H_{ci} (upper panel) and M_{796kA/m} (lower panel) for the various compositions as a function of time at 550° C. in air. Samples were not demagnetization corrected so M_{796kA/m} values are relative and not absolute.

FIG. 18 illustrates improved stability of coercivity at high temperatures (at 550° C. for indicated duration of hours) which enables higher temperature sintering for longer durations.

FIG. 19 illustrates low field magnetization (M_{1T}) is improved above the base alloy over long durations at 550° C.

### DETAILED DESCRIPTION OF THE INVENTION

Before the present invention is described in further detail, it is to be understood that the invention is not limited to the particular embodiments described. It is also to be understood that the terminology used herein is for the purpose of describing particular embodiments only, and is not intended to be limiting. The scope of the present invention will be limited only by the claims. As used herein, the singular forms “a”, “an”, and “the” include plural embodiments unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising”, “including”, or “having” should be interpreted as referring to elements, components, or steps in a non-exclusive manner, so the referenced elements, components, or steps may be combined with other elements, components, or steps that are not expressly referenced. Embodiments referenced as “comprising”, “including”, or “having” certain elements are also contemplated as “consisting essentially of” and “consisting of” those elements, unless the context clearly dictates otherwise. As used herein, “consisting essentially of” or “comprising substantially” means that specific further components can be present, namely those not materially affecting the essential characteristics of the compound or composition. It should be appreciated that aspects of the disclosure that are described with respect to a system are applicable to the methods, and vice versa, unless the context explicitly dictates otherwise.

The ferromagnetic τ phase in the Mn—Al system has been a promising candidate for permanent magnet applications to fill the gap between high-performance rare-earth magnets and lower-performance ferrite magnets. The tetragonal (L1₀) structure of the τ phase has a desirable combination of saturation magnetization, Mₛ˜161 Am²/kg, magnetocrystalline anisotropy energy (1.5 MJ/m³), and, thus, coercivity, H_{ci}, depending on its microstructure, giving it a maximum energy product, (BH)ₘₐₓ of ˜100 KJ/m³.

However, the progress to produce Mn—Al permanent magnets of (BH)ₘₐₓ comparable to the theoretical maximum has been obstructed by the metastable nature of the τ phase and the formation of defects, such as twins and anti-phase boundaries (APBs), during the phase transformation to τ phase.

The τ phase is formed from the high-temperature ε phase by a hybrid displacive-diffusional phase transformation involving an intermediate ordered ε′ phase. The transformation can proceed by either annealing the ε phase at ˜450° C. or by cooling from the ε phase at a rate of 3.5-10° C./s from >850° C. The displacive mode (ε ordering to ε′ followed by shear to τ) is observed to be kinetically dominant at <450° C. whereas the diffusional mode (compositionally invariant massive transformation from ε to τ) is kinetically dominant at >450° C. However, both transformation modes are believed to always occur simultaneously in varying proportions of dominance. The displacive transformation mode is also made dominant by alloying with C or increasing the Mn content, whereas a higher Al content will favor the diffusional mode. The hybrid displacive-diffusional phase transformation commonly produces twins, APBs, and stacking faults in the τ phase.

Unfortunately, APBs diminish (BH)ₘₐₓ in two primary ways. First, the APB acts as a nucleation site for reversing domains, thereby diminishing H_{ci} and Mᵣ. Second, the APB pairs Mn atoms across the boundary as anti-site defects that prefer AFM-coupling, thereby reducing Mᵣ and Mₛ.

Therefore, one aim of the instant disclosure is to find ways to reduce the formation and magnetic effects of APBs in Mn—Al permanent magnets. The APB defect is a disruption of

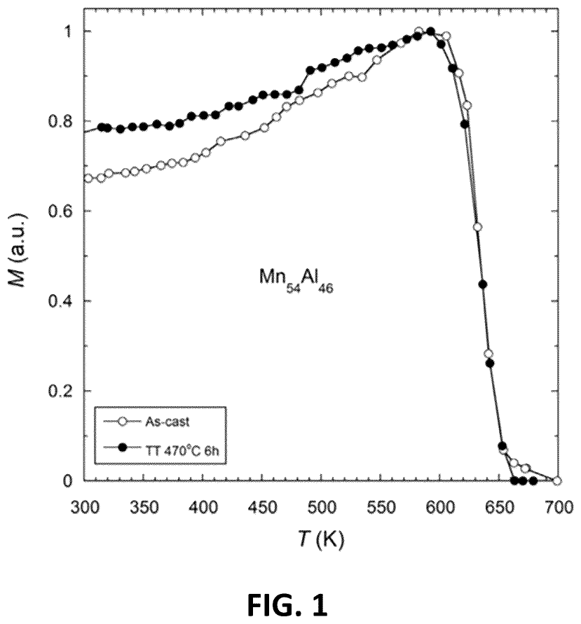

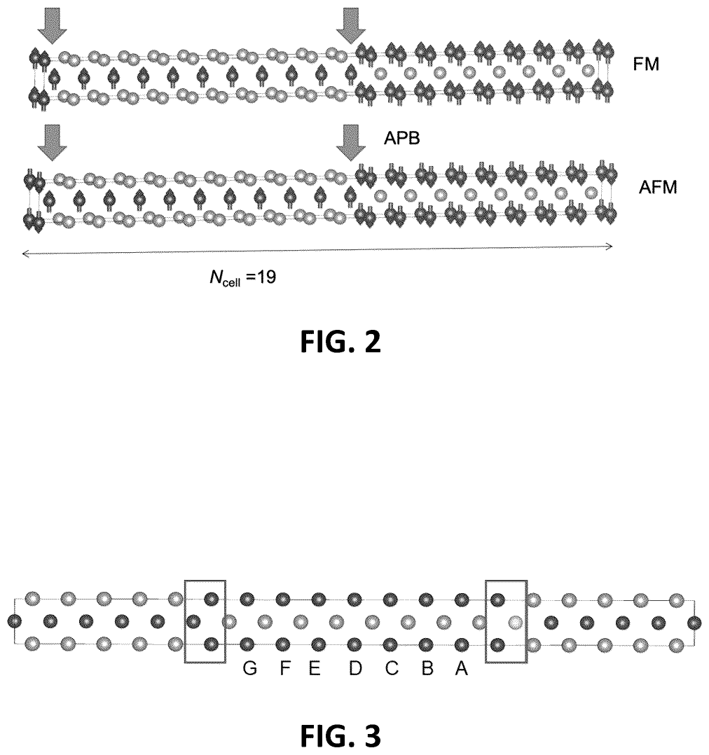

the binary L1₀ ordering of Mn and Al. It has been observed that APBs are a result of ½[101] lattice shearing during the hybrid displacive-diffusional phase transformation from the high-temperature ε phase. Néel-type AFM behavior has been observed in Mn—Al, during Curie temperature (T_{C}) measurements, as increasing M with temperature rather than the typical loss of M with temperature due to thermal perturbation. See, for example, FIG. 1. The geometry of an APB is shown in FIG. 2. A noticeable increase in M has been observed at temperatures as low as 100° C. and persists even in alloys annealed for 16 h at 550° C., making it improbable that the increase in magnetic moment is due to increased ordering of the L1₀ τ phase during the T_{C} measurement. Additionally, the Néel temperature, T_{N}, of the AFM ε phase is ˜−180° C., compared to the τ phase at ˜300° C., thus untransformed parent ε phase left over from the phase transformation to τ phase could likewise not explain the Néel-type behavior.

Comparatively, twins have a less clear impact on the magnetic properties of Mn—Al. While several studies have claimed a negative effect of twins on Mᵣ, and H_{ci}, those studies have not separated the effects of twins from the effects of APBs. The only consensus in the literature is that APBs have a negative effect on H_{ci}. Twins, on the other hand, are correlated with lowered Mᵣ and H_{ci} but may not actually be the causal element.

In addition to controlling defects, the thermal stability of Mᵣ, and H_{ci} is of particular interest in processing Mn—Al into commercially viable permanent magnets. The conventional permanent magnet processing technique is to mill the ferromagnetic (FM) powder to a fine grain size and high dislocation density, align in a magnetic field, then sinter into a high-density bulk permanent magnet at elevated temperature. However, due to the metastable nature of the τ phase, it is common for H_{ci} and Mᵣ to be reduced due to defects annealing out, grain coarsening, or phase decomposition during any of these steps. This is also applicable to recent, more advanced PM processing techniques, such as additive manufacturing. Accordingly, it is to be appreciated that any inherent improvement to the thermal stability of H_{ci} or Mᵣ by a ternary alloyant will greatly improve the real-world processability of the τ phase.

The work disclosed herein utilities ab initio modeling as a tool to rapidly screen multiple elements for their ability to suppress APBs by two main characteristics: a) an element's affinity to segregate to the APB rather than sit in the bulk, and b) an element's tendency to promote ferromagnetic coupling across the APB compared to AFM-coupling. This disclosure identifies an addition of titanium in a targeted amount as an effective method to reduce the APB density in Mn—Al and, thereby, prevent AFM behavior in the τ phase. It also identifies other effects from Ti addition on the microstructure and shows how these microstructural changes positively benefit the magnetic properties.

Notably, titanium has previously been tested as a ternary alloyant in Mn₅₄Al₄₆ substituting 2 at. % and 4 at. % for Mn. However, these compositions resulted 35 wt. % to 75 wt. % τ phase, with a remainder fraction of γ₂ phase in Mn₅₂Al₄₆Ti₂ and a remainder fraction of a mix of γ₂ phase and a soft magnetic κ phase (prototype CsCl) in Mn₅₀Al₄₆Ti₄ in [Gavrea R, Hirian R, Mican S, Benea D, Isnard O, Coldea M, Pop V. Structural, electronic and magnetic properties of the Mn54-xAl46Tix (x=2; 4) alloys. Intermetallics (Barking) 2017; 82:101-6.] and so did not arrive at the improvements surprisingly and unexpectedly found and disclosed herein at a lower amount of titanium addition.

The κ phase has also been observed in Mn—Al—Ni alloys and, due to its lower values magnetocrystalline anisotropy, T_{S}, and Mₛ, it does not improve the magnetic properties of the τ phase and should be avoided. Therefore, this work of this study focused on lower concentrations of Ti (≤2 at. %) to avoid κ phase formation.

The following is provided by way of example only and to describe the concepts or provide proof-of-concept through experimental data. One having ordinary skill in the art will appreciate that these examples are not limiting, but only help to illustrate some of the applications and structures falling within the scope of the claims.

### Material and Methods

Alloys of composition Mn₅₄Al₄₅Ti₁ and Mn₅₃Al₄₆Ti₁ were cast using arc-melting under an Ar atmosphere. The cast buttons were flipped 3 times to ensure homogeneity. Excess (6 wt. % Mn) was added to each alloy to achieve the desired composition due to the higher vapor pressure of Mn relative to Al, Ti, and Sn. A reference Mn₅₄Al₄₆ alloy was prepared via induction melting by Sophisticated Alloys, Inc. of Butler, PA. Alloy composition and homogeneous distribution of Ti and Sn was confirmed via electron dispersive spectroscopy (EDS) in a Tescan Vega3 scanning electron microscope (SEM). Differential scanning calorimetry (DSC) was performed in a TA instruments Q20 from 30-600° C. under flowing Ar at ramp rates of 5-80° C./min. The ε phase of each alloy was prepared by annealing at 1100° C. for 70 minutes in a sealed alumina tube followed by quenching into deionized water. The tube was evacuated to −85 kPa and backfilled with Ar gas to 15 kPa to minimize oxidation. The ε phase was transformed to τ at the temperature identified via DSC for a duration where magnetization and coercivity were both optimized. For Mn₅₄Al₄₆ this was 450° C. for 30 minutes and for both Mn₅₄Al₄₅Ti₁ and Mn₅₃Al₄₆Ti₁ this was 550° C. for 60 minutes. Transmission electron microscopy (TEM) was performed in an FEI Tecnai F20ST FEG TEM at 200 kV to analyze the twins and APBs. Electron backscatter diffraction (EBSD) was done in a Thermo Fisher Helios 5 SEM to characterize grain size, orientation, texture, dislocation density, and for phase identification. TEM sample preparation utilized focused ion beam (FIB) milling in the Helios 5 SEM. X-ray diffraction in a Rigaku UltraX XRD with a Cu-anode (λ=0.154 nm) was used to identify the phase volume fractions and lattice parameters. T_{C} and hysteresis curves were measured in a Lakeshore 7300 vibrating sample magnetometer (VSM) equipped with a high temperature furnace. High-field VSM was performed in a 9 T Quantum Design PPMS Dynacool with VSM. Room temperature VSM was demagnetization corrected based on rectangular prism sample geometry using the model from. Transmission electron microscopy (TEM) was performed in an FEI Tecnai F20ST FEG TEM at 200 kV to analyze the twins and APBs. Electron backscatter diffraction (EBSD) was done in a Thermo Fisher Helios 5 SEM to characterize grain size, orientation, texture, dislocation density, and for phase identification. TEM sample preparation utilized focused ion beam (FIB) milling in the Helios 5 SEM. X-ray diffraction in a Rigaku UltraX XRD with a Cu-anode (λ=0.154 nm) was used to identify the phase volume fractions and lattice parameters. Differential scanning calorimetry (DSC) was performed in a TA instruments Q20 from 30-600° C. under flowing Ar at ramp rates of 5-80° C./min. The ε phase of each alloy was prepared by annealing at 1100° C. for 70 min in a sealed alumina tube followed by quenching into deionized water. The tube was evacuated to −85 kPa and backfilled with Ar gas to 15 kPa to minimize oxidation. The ε phase was transformed to τ at the temperature identified via DSC for a duration where magnetization and coercivity were both optimized. For Mn₅₄Al₄₆ this was 450° C. for 30 min and for both Mn₅₄Al₄₅Ti₁ and Mn₅₃Al₄₆Ti₁ this was 550° C. for 60 min. Thermal stability studies were performed at 250° C. (for 40 days) and 550° C. (for 1 week) by progressively annealing samples in air and performing VSM measurements at fixed intervals.

### Calculations

Ab-initio modeling was used to model the effects of different ternary element additions to the τ phase. Spin-polarized calculations were made with density functional theory (DFT) in the Vienna Ab-initio Simulation Package (VASP) using the projector augmented wave (PAW) method and the generalized gradient approximation with the Perdew-Burke-Ernzerhof (GGA PBE) exchange-correlation functionals. A unit cell of the L1₀ τ phase with experimental lattice parameters was relaxed to a cutoff energy of 520 eV using the plane-wave-basis set until the target force of less than 0.01 eV/Å was reached. A 10⁻⁶ eV convergence criterion of the electronic self-consistent field (SCF) loops was used. Monkhorst-Pack k-point grids with a grid density of 2000 points/atom were chosen. To model the APB behavior in the τ phase, the same DFT VASP code was used. The initial unit cell state for the τ phase was calculated with PAW PBE 5.4, an energy cutoff equal to 450 eV, and a Monkhorst-Pack k-point grid of 23×23×17 of the Brillouin zone. A Mn₂₀Al₁₈ APB model of 19 cells and 38 atoms was chosen.

To evaluate the tendency for the ternary element to segregate to the APB compared to the bulk, the energy of formation was calculated for the APB defect, comparing substitution on the Mn site (shown in center-right position of the right box in FIG. 3) with substitution to the bulk (at the “D” site shown in FIG. 3) as follows:

$${E}^{F} [ Z ] = {E}^{t o t} [ A P B ] - {E}^{t o t} [ bulk ] - ( - 1 ) {μ}^{M n} - ( 1 ) {μ}^{Z} \qquad ( 1 )$$

where E^{F} is the energy of formation of the APB when substituting the ternary element, Z, for Mn at the APB, E^{tot} is the total energy for the ternary element at a given location (at the APB or in the bulk), and μ is the chemical potential for Mn or Z. Therefore, if E^{F}[Z] is negative, the APB is favored to form in the presence of Z and the substitutional atom is therefore favored to segregate to the APB compared to the bulk, as desired. The next part of the screening process compared the FM versus AFM energies with the ternary element substituted for Mn on the APB. The AFM APB's energy was compared to the FM APB's energy with the substitutional atom on the Mn site of the APB in both cases, and the difference in energy was calculated.

The Kissinger method was used to determine activation energies from DSC measurements (See Kissinger H E. Reaction Kinetics in Differential Thermal Analysis. vol. 28.1956). The Kissinger method is based on an Arrhenius model of reaction rates:

$$ln ( β / {T}_{max}^{2} ) = \{ ln ( AR / {E}_{a} ) + ln [ {n ( 1 - α )}^{n - 1} ] \} - {E}_{a} / {RT}_{max}$$

where B is the heating rate, Tₘₐₓ is the exotherm peak temperature, A is the Arrhenius factor, R is the molar gas constant, Eₐ is the activation energy, n is the reaction order, and α is the fraction transformed. DSC curves at β values of 5-80° C./min yielded a plot of In(β/Tₘₐₓ²) against ⊕1/Tₘₐₓ. The slope of the ordinary least squares (OLS) regression line (Eₐ/R) was used to calculate Eₐ.

### Ab-initio Modeling

Candidate ternary elements of Bi, Co, Cr, Cu, Fe, Ge, Ni, Sn, Ti, V, Zn, and Zr were screened using DFT to understand how they interacted with an APB. The Mn₅₀Al₅₀ L1₀ τ phase structure was relaxed to the lattice parameters a=2.755 Å, c=3.471 Å, in good agreement with the experimental parameters in Table 3 (below). This ground state had an average magnetization along the magnetically-easy c-axis of μ_{Mn}=2.264 μB per Mn atom, μ_{Al}=−0.050 μB per Al atom and a total average magnetization of 1.107 μB per atom in the Mn₅₀Al₅₀ functional unit. The supercell of Mn₂₀Al₁₈ used to model the APB, which is shown in FIGS. 2 and 3, consists of 19 cells and 38 atoms. Two APBs are present due to the periodic boundary conditions of the model. At the APB interface the magnetic moments of the Mn atoms are shown as collinear along the c-axis, in the FM (spins aligned, top panel of FIG. 2) and AFM (spins opposed, bottom panel of FIG. 2) configurations.

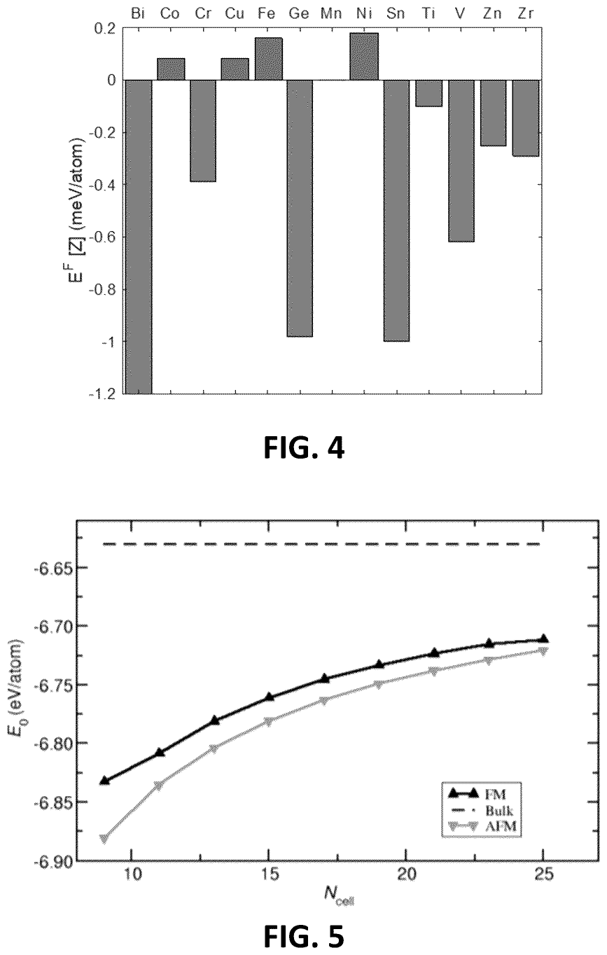

The two criteria for choosing ternary elements were as follows: a) does the ternary element segregate to the APB compared to the bulk, and b) does the ternary element favor the FM configuration over the AFM configuration. The results for 12 candidate elements are shown in FIGS. 4 and 5. The 12 elements (Bi, Co, Cr, Cu, Fe, Ge, Ni, Sn, Ti, V, Zn, and Zr) were chosen based on either their known behavior as ternary alloyants in the Mn—Al or Mn-based magnetic systems or based on their low raw material cost.

To evaluate the tendency for the ternary element to segregate to the APB compared to the bulk, the energy of formation was calculated for the APB, comparing substitution on the Mn site (shown as the rightmost atom of the center row of the rightmost the box in FIG. 3) with substitution to the bulk (at the “D” site shown in FIG. 3) as follows:

$${E}^{F} [ Z ] = {E}^{t o t} [ A P B ] - {E}^{t o t} [ bulk ] - ( - 1 ) {μ}^{M n} - ( 1 ) {μ}^{Z} \qquad ( 1 )$$

where E^{F} is the energy of formation of the APB when substituting the ternary element, Z, for Mn at the APB, E^{tot} is the total energy for the ternary element at a given location (at the APB or in the bulk), μ^{Mn} is the chemical potential for Mn, and μ^{Z} is the chemical potential for Z (the ternary element). Therefore, if E^{F}[Z] is negative, the APB is favored to form in the presence of Z and the substitutional atom is therefore favored to segregate to the APB compared to the bulk, as desired. FIG. 4 shows that, of the candidate elements studied, all except Fe, Co, Ni, and Cu favor segregating to the APB. 54-atom supercells of the fully ordered t phase were relaxed with DFT to understand the preferred location of the Ti atom in the absence of an APB defect. By performing a parallel calculation to the equation for E^{F}[Z], above, the Ti substitutional defect formation energy for Mn₂₆Al₂₇Ti₁ (Ti on Mn site) was 0.353 eV and the defect formation energy for Mn₂₇Al₂₆Ti₁ (Ti on Al site) was −0.063 eV. This indicates that that the Ti atom prefers the Al site in the bulk τ phase.

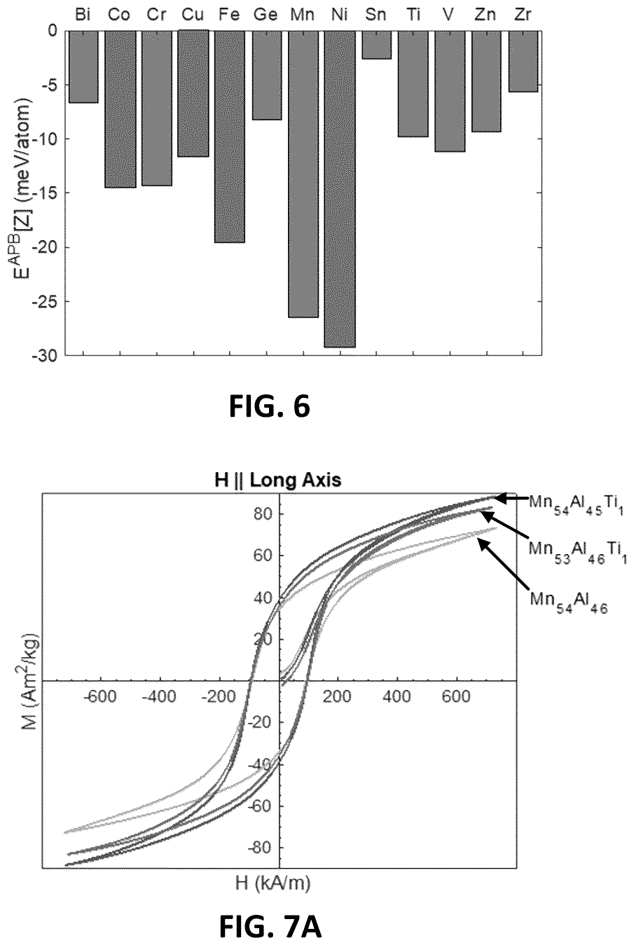

The next part of the screening process compared the FM versus AFM energies with the ternary addition substituted for Mn on the APB. First, the FM versus AFM characteristics of the APB without ternary substitution on the Mn site were calculated and compared to the bulk without any APB present, as shown in FIG. 3. The number of unit cells, N_{cell}, in the model were varied from 9 to 25 to establish any effects of increasing the supercell, see FIG. 5. Over the entire range of N_{cell}, the AFM arrangement is more stable at the APB than the FM configuration. The two curves will eventually converge to the bulk value of −6.63 eV/atom as N grows sufficiently large. Since these results were in good agreement with previous modeling using N=19, this same supercell size was chosen. The formation energy for the AFM APB configuration with the substitutional atom on the Mn APB site were then calculated from:

$${E}^{A P B} [ Z ] = {E}^{t o t} [ AFM ] - {E}^{t o t} [ F M ]$$

where the more negative E^{APB} is for an element, the more stable the AFM configuration is at the APB compared to the FM configuration. As shown in FIG. 6, none of the candidate elements resulted in a positive value for E^{F}. However, multiple elements made the FM configuration more stable compared to the case of Mn sitting on the APB, as desired. All the candidate elements, except Ni, were shown to stabilize the FM configuration compared to the Mn baseline, as desired, but Fe, Co, and Cu were eliminated given their preference for the bulk rather than segregating to the APB. Given the limitations of this model (finite supercell size, Mn-rich composition compared to experiment, and simplified geometry of the APB) the relative change in E^{APB} is more meaningful than its absolute value—that is, E^{APB}[Z] does not necessarily need to be greater than zero for the AFM versus FM nature of the APB to be affected in a real material. Any meaningful effects must be validated through experiment, as will be done below.

Therefore, the candidate elements from these calculations that met both criteria to segregate to the APB and make FM more stable were: Bi, Cr, Ge, Ti, Sn, V, Zn, and Zr. Of these elements, Ti and Sn were chosen due to their lack of previous investigation as a ternary alloyant in Mn-based magnets and due to their relatively low raw material cost. Preliminary magnetic studies of the t phase for 1 at. % Sn and 2 at. % Ti did not show any improvement over Mn₅₄Al₄₆, therefore this study was focused on 1 at. % Ti addition.

### Initial Results

Alloys of Mn₅₄Al₄₆₋ₓTiₓ and Mn₅₄₋ₓAl₄₆Tiₓ (x=1, 2) and Mn₅₃Al₄₆Sn₁ were cast in the same manner and evaluated based on their t phase magnetic properties as an initial screening process.

After transforming to the t phase, initial results from 1 at. % Sn addition were very poor, with H_{ci}=78 kA/m (84% of the Mn₅₄Al₄₆ base alloy) reference and M_{796 kA/m}=46 Am²/kg (only 65% the Mn₅₄Al₄₆ base alloy). Because the t phase does not saturate at the maximum field possible in the VSM used in this investigation, 796 kA/m, the M_{796 kA/m} value is given to represent the magnetic moment at this field but not the true Mₛ. Therefore, this composition was not considered of acceptable magnetic performance for further consideration.

Likewise, the alloys with 2 at. % Ti, Mn₅₄Al₄₄Ti₂ (H_{ci}=62 kA/m, M_{796 kA/m}=52 Am²/kg) and Mn₅₂Al₄₆Ti₂ (H_{ci}=92 kA/m, M_{796 kA/m}=69 Am²/kg) similarly did not demonstrate an improvement in magnetic performance compared to Mn₅₄Al₄₆.

However, alloys with 1 at. % Ti addition demonstrated a significant improvement over the base alloy and, as such, were the primary focus of this further investigation. 54 atom DFT supercells of the fully ordered τ phase were generated to understand the preferred location of the Ti atom in the absence of an APB defect. Ground state energies for Mn₂₇Al₂₇, Mn₂₆Al₂₇Ti₁ and Mn₂₇Al₂₆Ti₁ were calculated as −7.131 eV/atom, −7.101 eV/atom, and −7.209 eV/atom, indicating that the Ti atom prefers the Al site in the absence of an APB defect.

### Magnetic Properties

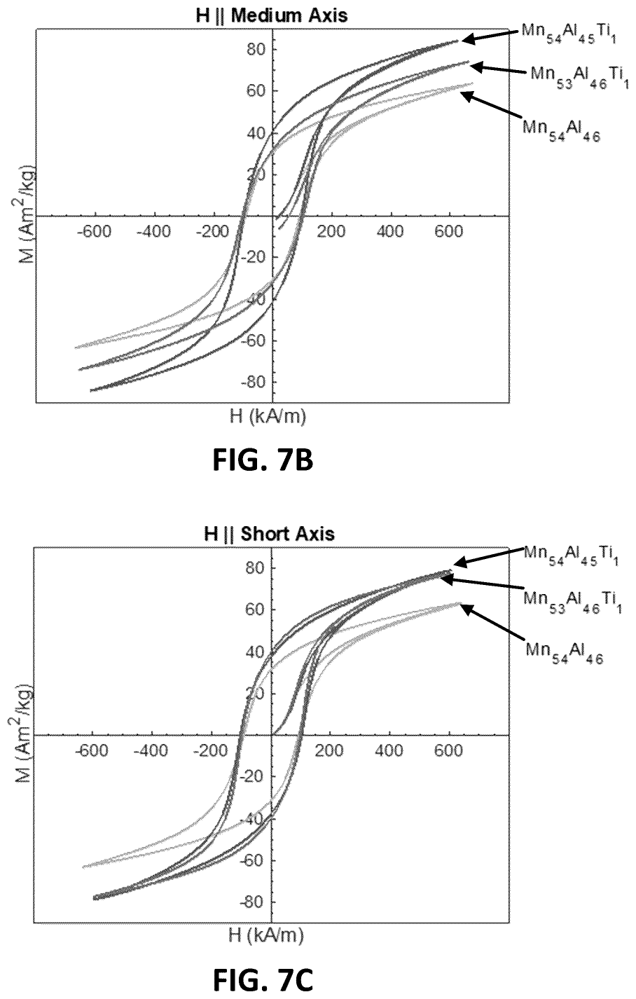

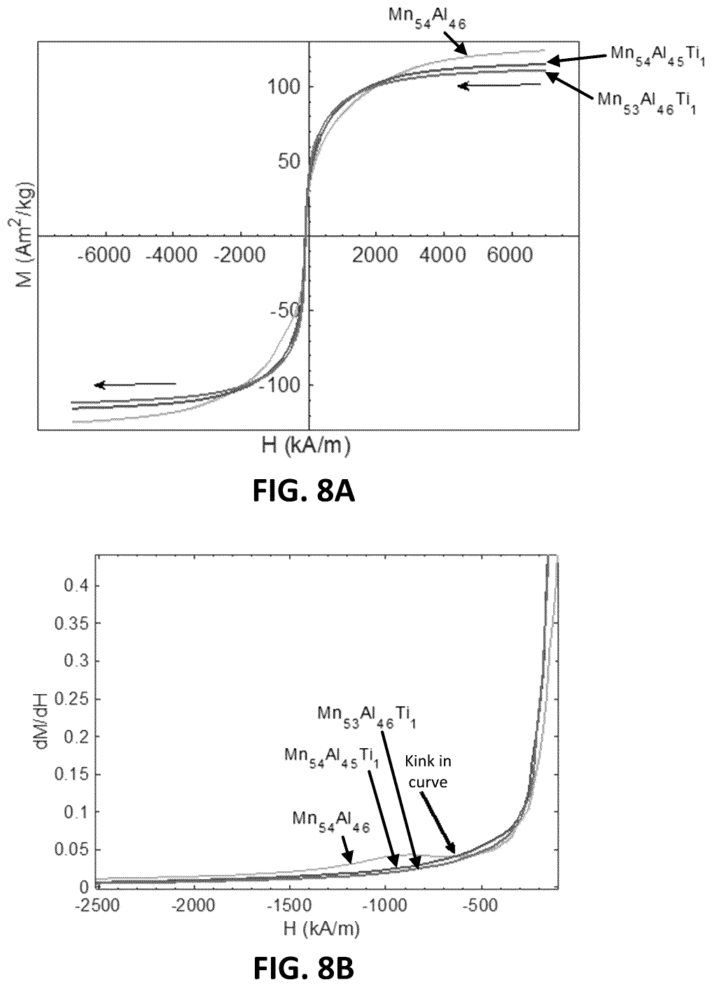

The VSM curves in FIGS. 7A, 7B, 7C, and 8A show the effects of 1 at. % Ti substituted for either Mn or Al in Mn₅₄Al₄₆ in as-annealed isotropic samples. FIGS. 7A, 7B, and 7C contain demagnetization-corrected data used to accurately measure Mᵣ, H_{ci}, and (BH)ₘₐₓ, whereas FIGS. 8A and 8B were not demagnetization corrected but give a high-field value approaching the true Mₛ. Specific values from VSM data are listed in Table 1, below, which shows the average magnetic properties of the Mn—Al—Ti alloys measured via VSM and their phase transformation peak temperatures measured via DSC. The data show that, as-annealed the addition of Ti slightly improves H_{ci} by ˜8% for both alloys and significantly improves Mᵣ by 13% and 22% for Mn₅₃Al₄₆Ti₁ and Mn₅₄Al₄₅Ti₁, respectively. Consequently, (BH)ₘₐₓ is improved by 33% in Mn₅₄Al₄₅Ti₁ over the base alloy. To eliminate crystal texture as a cause of the improved remanence, VSM measurements were made in three perpendicular orientations for each sample: the short, medium, and long axes of each rectangular prism sample, and all VSM curves were demagnetization corrected using the model in Aharoni A. Demagnetizing factors for rectangular ferromagnetic prisms. J Appl Phys 1998; 83:3432-4. The data have been averaged for the three orientations into the values of H_{ci}, Mᵣ, and (BH)ₘₐₓ in Table 1.

TABLE 1

| Magnetic | Alloy | | |
|---|---|---|---|
| Property (Units) | Mn₅₄Al₄₆ | Mn₅₃Al₄₆Ti₁ | Mn₅₄Al₄₅Ti₁ |
| Mₛ (Am²/kg) | 124 | 112 | 115 |
| (at 7162 kA/m) | | | |
| H_{ci} (kA/m) | 92 | 99 | 99 |
| (BH)ₘₐₓ (kJ/m³) | 4.2 | 4.9 | 5.6 |
| Mᵣ (Am²/kg) | 32 | 36 | 39 |
| T_{C} (° C.) | 375 | 365 | 373 |

The VSM curves in FIGS. 7A, 7B, and 7C show that the susceptibility, χ=M/H, and Mᵣ are significantly improved for the alloys with Ti addition at low fields in each direction measured. This is despite the fact that at higher fields the Mₛ of the Mn₅₄Al₄₆ alloy is ˜10% greater than with the Ti addition, as shown in the high-field VSM measurement shown in FIG. 8A. Were this due to anisotropic crystal texture or grain shape in the samples with Ti addition, then the effect would be pronounced in one direction, but would not be in all three directions. Another mechanism besides anisotropy must be responsible for the improvement. Taking the derivative form of susceptibility yields dχ=dM/dH, allowing the non-linear relationship between M and H to be observed in this material as depicted in FIG. 8B. Clearly, the differential susceptibility of the alloys with 1 at. % Ti is greater at low fields up to 600 kA/m, where the Mn₅₄Al₄₆ alloy's reversal behavior changes. Looking at the annotation arrow in FIG. 8B, there is not only a crossover in the dχ curves where Mn₅₄Al₄₆ becomes the highest dχ, but at this point there is also a noticeable kink in the M-H curve. Sudden, non-linear, increases in M with increasing H have been observed in the literature as evidence of metamagnetism in highly-ordered Mn₅₀Al₅₀ as a result of AFM ordering. In other words, if there is a significant fraction of the τ phase that is taking on an AFM configuration, then it can become evident as a spin-flop from AFM to FM when a sufficiently high field is applied to overcome the crystalline anisotropy of the AFM configuration.

As stated previously, DFT modeling demonstrated that APBs prefer the AFM configuration to the FM configuration. Therefore, if there is a sufficiently high density of APBs then the transition from AFM to FM at high fields will be noticeable in VSM measurements, and the superposition of the AFM reversal on top of the FM reversal will appear as a sudden increase in dM/dH, or a kink in the M-H curve. Similar to high-fields, high-temperatures should flip AFM behavior to paramagnetic above the Néel temperature via thermal perturbation. Thermal VSM was thus performed on the Mn—Al—Ti alloys to further understand the mechanism for improvement in χ and Mᵣ with 1 at. % Ti as well as the reversal kink in Mn₅₄Al₄₆.

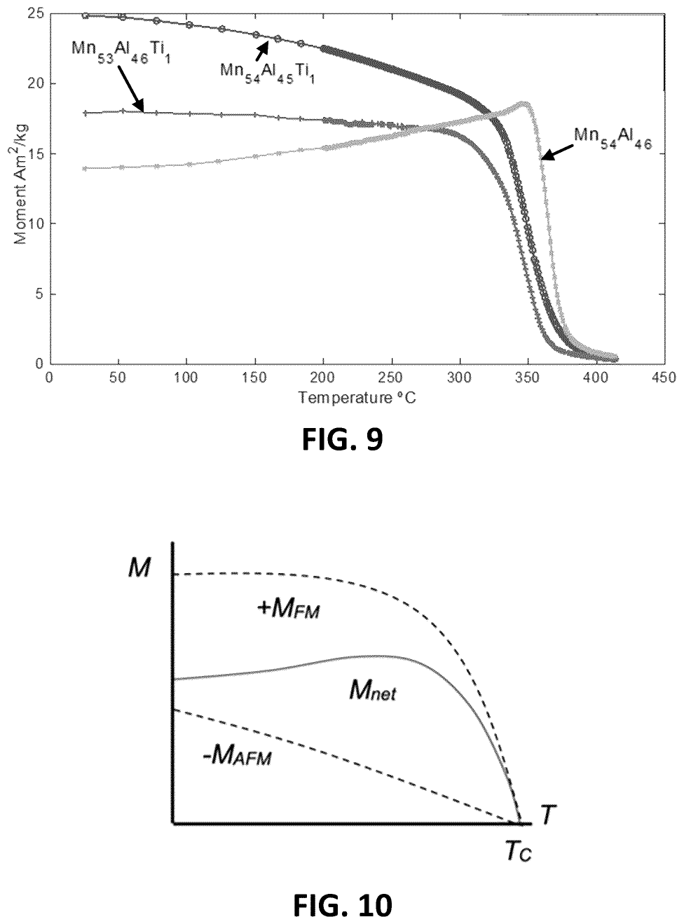

The magnetic moment of the Mn—Al—Ti alloys with increasing temperature is shown in FIG. 9. FIG. 9 shows the T_{C} data for the three alloys when the t phase was heated from room temperature up to 415 °C. The addition of Ti lowers T_{C} from 375° C. in Mn₅₄Al₄₆ to 365° C. in Mn₅₃Al₄₆Ti₁. However, it also has a noticeable effect on the slope of the magnetization curve under heating. In the alloys with Ti, the slope is always negative, as expected following Curie FM behavior, whereas the sample without Ti has a positive slope up to near T_{C}, indicative of Néel AFM behavior. As is typical of FM materials, the 1 at. % Ti alloys have a negative trend of M with increasing T up to T_{C}. As the temperature approaches T_{C}, there is a dramatic loss of M as a consequence of the transition from FM to paramagnetic. In contrast, Mn₅₄Al₄₆ has an increase in M up to near T_{C}. This again suggests a significant amount of AFM behavior within the Mn₅₄Al₄₆ sample. As stated above, increasing M with temperature is a previously documented phenomenon in Mn—Al but it has not been the subject of in-depth inquiry. The positive trend of M with T is indicative of incomplete AFM Néel-type behavior superposed upon the majority FM τ phase Curie behavior. This sums to behavior similar to that observed in certain ferrimagnets such as NiO⋅Cr2O3, as shown in FIG. 10, which is reproduced from Cullity B D, Graham C D. Introduction to Magnetic Materials. Second. Piscataway: John Wiley and Sons Inc.; 2009. This is possible when the M of the FM phase decreases less with temperature than the −M of the AFM fraction (the APBs). It is worth noting that, in FIG. 9, the slope of the Mn₅₃Al₄₆Ti₁ alloy is negative but nearly flat up to 300° C., somewhere between the positive slope of Mn₅₄Al₄₆ and the more negative slope of Mn₅₄Al₄₅Ti₁. As will be discussed later, the density of APBs in Mn₅₃Al₄₆Ti₁ lies in between the other two alloys. Therefore, the slope of M with increasing T is evidently more negative with lower APB density. In other words, the Mn₅₄Al₄₆ has the highest APB density and shows the most AFM behavior, Mn₅₄Al₄₅Ti₁ has the lowest APB density and shows no clear AFM behavior, and Mn₅₃Al₄₆Ti₁ has an APB density in between these two with only a subtle apparent AFM behavior in the M-T plot.

The T_{N} of AFM Mn—Al is reported to be ˜300° C. for Mn₅₀Al₅₀, ˜75° C. less than the T_{C} for the FM τ phase. However, given that the M continues to increase up to ˜350° C. in the Mn₅₄Al₄₆ curve, it appears that the T_{N} of this composition is higher. This could be a compositional effect, where T_{N} changes with Mn content, or a result of stabilization of spin within AFM domains by the FM τ phase. Considering the case where the AFM behavior arises from APBs within the FM τ phase, which are only one atom thick, it is plausible that the exchange between the FM phase and the AFM defect region becomes exchange-coupled so that the FM phase stabilizes the spin configuration of the AFM APB region and increase T_{N}.

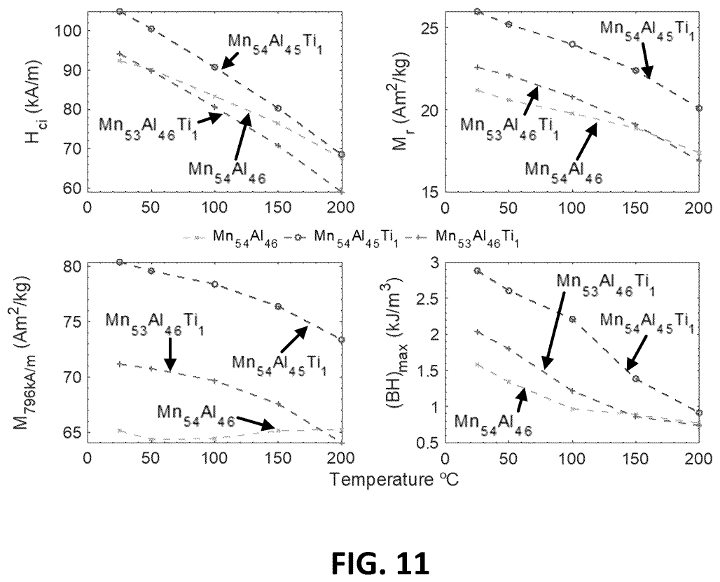

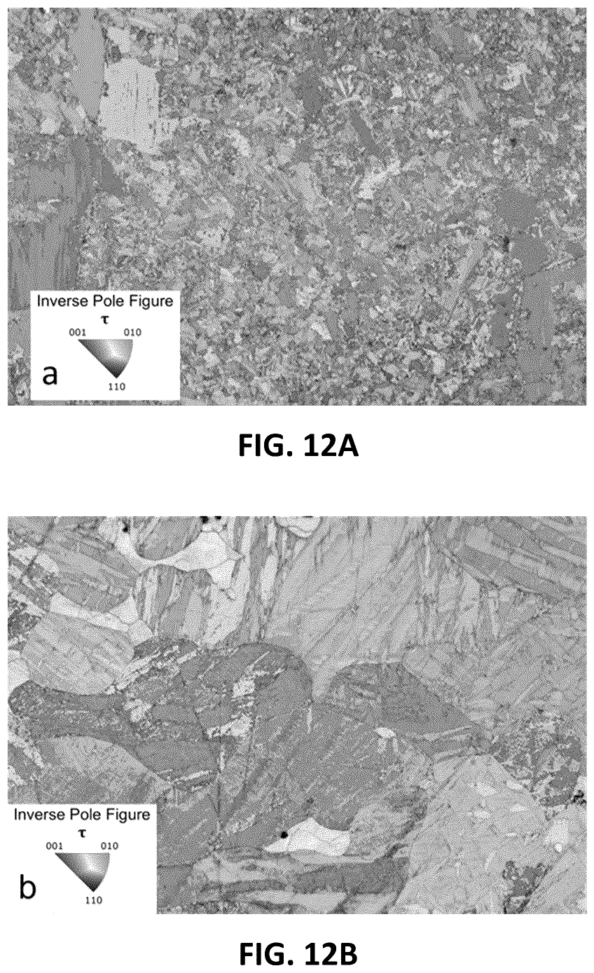

The alloys' magnetic properties were also measured at different temperatures using the VSM. The results are plotted in FIG. 11. VSM hysteresis curves were collected at 25° C.-200° C. at 50° C. intervals. Each sample was kept in the same orientation to the applied field but not demagnetization corrected. Therefore, effects from texture and shape demagnetization may be present in (BH)ₘₐₓ, Mᵣ, and M_{796 kA/m}, and should be understood in terms of their relative change with temperature rather than in their absolute values. Note that because the τ phase does not saturate at the maximum field possible in the VSM used, 796 kA/m, the M_{796 kA/m} value is given to represent the magnetic moment at this field but not the true Mₛ.

Unlike the Mn—Al—Ti alloys, the M_{796 kA/m} of Mn₅₄Al₄₆ increases with temperature. This is further evidence of AFM behavior in the alloy without Ti, where instead of thermal perturbations reducing M following an FM Curie behavior trend the thermal perturbations increase M due an AFM Néel effect flipping atom spins from AFM to paramagnetic. By contrast, the Mᵣ of Mn₅₄Al₄₆ does indeed decrease with temperature. Since Mᵣ is measured at zero applied field, H=0, there is no contribution from any paramagnetic fraction. Therefore, if the AFM fraction in Mn₅₄Al₄₆ is made partially paramagnetic as the temperature moves closer to T_{N}, then it logically follows that the paramagnetic fraction offsets M losses to the FM fraction at elevated temperatures and fields (H=796 kA/m), increasing M_{796 kA/M} overall. In theory, the paramagnetic AFM fraction does nothing to increase Mᵣ at H=0 since there is no applied field, in good agreement with the evidence.

The thermal coefficient of Mᵣ and H_{ci} were calculated using a linear least-squares best-fit for each alloy. Mᵣ coefficients of −0.10%/° C., −0.13%/° C., and −0.14%/° C. were measured for Mn₅₄Al₄₆, Mn₅₄Al₄₅Ti₁, and Mn₅₃Al₄₆Ti₁, respectively. The Mᵣ coefficient for Sm—Co is ˜−0.035%/° C. and for Nd—Fe—B is ˜−0.1%/° C. from the literature. H_{ci} coefficients of −0.15%/° C., −0.20%/° C., and −0.21%/° C. were measured for Mn₅₄Al₄₆, Mn₅₄Al₄₅Ti₁, and Mn₅₃Al₄₆Ti₁, respectively. These are all roughly one-third the negative thermal coefficient of H_{ci} for Nd—Fe—B (−0.6%/° C.), and as good if not slightly better than Sm—Co at −0.2%/° C. to −0.31%/° C., depending on the composition.

This is noteworthy because, due to these trends, (BH)ₘₐₓ for Nd—Fe—B PMs drops off sharply at elevated temperatures, losing ˜80% of room temperature performance at 200° C., which limits its performance range. By contrast, 49%, 32%, and 36% of room temperature (BH)ₘₐₓ was maintained at 200° C. for Mn₅₄Al₄₆, Mn₅₄Al₄₅Ti₁, and Mn₅₃Al₄₆Ti₁, respectively.

Based on the combined results from the high-field VSM and the thermal VSM, there is clear evidence of AFM behavior in Mn₅₄Al₄₆ in addition to the expected FM behavior of the τ phase. Therefore, given the microstructural evidence of lowered APB density with Ti addition and the lack of AFM behavior in the Mn—Al—Ti alloys, the APBs are the most likely source of the AFM behavior and suppressing their formation has a positive impact on the magnetic properties.

### Composition and Lattice Parameters

The composition of the Mn—Al—Ti alloys were confirmed via EDS as shown in Table 2, with compositions within 0.5 at. % of the target composition.

TABLE 2

| Composition | Mn₅₃Al₄₆Ti₁ | Mn₅₄Al₄₅Ti₁ |
|---|---|---|
| Mn | 52.5 ± 0.19 | 54.2 ± 0.8 |
| Al | 46.5 ± 0.2 | 44.7 ± 0.8 |
| Ti | 1.0 ± 0.03 | 1.1 ± 0.06 |

Table 3 below shows refined lattice parameters and phase weight percent fractions of the Mn—Al—Ti alloys determined via XRD for each of the compositions. The addition of 1 at. % resulted in a small lattice expansion in both the c and a dimensions of the t unit cell, as shown in Table 3. While increasing the volume of the unit cell has been shown to improve the magnetic moment per atom, these changes of 0.5% are not large enough to cause the improvement in M, and do not explain the loss of Mₛ.

TABLE 3

| Property | Mn₅₄Al₄₆ | Mn₅₃Al₄₆Ti₁ | Mn₅₄Al₄₅Ti₁ |
|---|---|---|---|
| a (Å) | 2.7763 ± 0.0003 | 2.7820 ± 0.0007 | 2.7817 ± 0.0004 |
| c (Å) | 3.5737 ± 0.0004 | 3.5783 ± 0.0010 | 3.5771 ± 0.0006 |
| Volume (Å³) | 27.546 | 27.695 | 27.680 |
| | | (0.5% change) | (0.5% change) |
| τ phase wt. % | 98.5 ± 0.9 | 80.4 ± 0.3 | 95.0 ± 1.5 |
| γ₂ phase wt. % | 1.0 ± 0.4 | 6.1 ± 1.0 | 2.5 ± 1.1 |
| β phase wt. % | 0.5 ± 0.1 | 13.5 ± 1.0 | 2.6 ± 0.3 |

### Microstructure

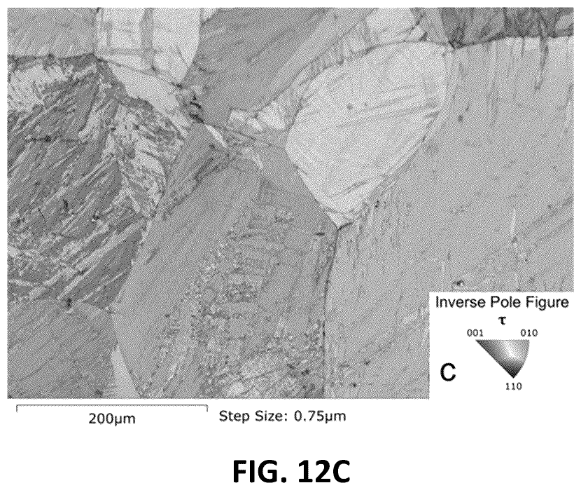

The microstructure of the Mn—Al—Ti alloys was characterized using X-Ray Diffraction (XRD) and Electron Backscatter Diffraction (EBSD) as summarized in Tables 3 and 4. True twins (76° misorientation) were significantly increased in the Mn—Al—Ti alloys. There was a negligible effect on the geometrically-necessary dislocation (GND) density and the prevalence of order twins (86° misorientation) and pseudo-twins (48° misorientation). All three compositions had a GND density of ˜2−3·10¹⁴/m². Because the three alloys could not be transformed to the τ phase using an identical heat treatment, it is possible that differences in the grain size between the three alloys were influenced by coarsening rather than intrinsically related to Ti addition. The heat treatments were chosen to minimize this effect. Twins and dislocations are an inherent byproduct of the hybrid transformation to the τ phase and are not affected in the same manner, that is, neither would increase in density due to prolonged annealing after the phase transformation is complete. The primary impacts of adding 1 at. % Ti include increased density of true twins (76° misorientation), increased grain size, and increased presence of secondary phases γ₂ and β. Previous theories in the literature suggest that these three factors should all act to diminish H_{ci} and Mᵣ. However, while the negative effects of grain size and secondary phases are well established, the effects of twins are less well established. The highly-twinned microstructure is clearly visible when comparing the alloys with and without 1 at. % Ti addition in FIGS. 12A, 12B, and 12C and show the grain morphology between the three alloys using EBSD. Whereas the Mn₅₄Al₄₆ alloy is characterized by mostly small, randomly oriented grains and some large twinned grains, the Mn—Al—Ti alloys have much larger grain regions intersected by a high density of twins which appear to originate on the grain boundaries. The twinned regions are visible as long striations growing out from the grain boundaries, a morphology that agrees with previous EBSD studies on Mn—Al. While the twinned grains are distributed homogeneously throughout the Mn—Al—Ti alloys, only a few large grains containing a high density of twins are visible in FIG. 12A, surrounded by a majority of small grains which contain a low density of twins. By contrast, the Mn—Al—Ti samples in FIGS. 12B and 12C consist of large grains intersected by a high density of twins and very few small individual grains. The reason the grain size measurement for the Mn—Al—Ti is not far greater than for Mn₅₄Al₄₆ is due to the highly-twinned morphology. Because of the misorientation, each twinned region is indexed as a separate grain, despite appearing to be enclosed by large, shared grain boundaries. Because neither H_{ci} nor Mᵣ were diminished in the VSM data, the high density of twins does not appear to negatively affect these properties in Mn—Al—Ti alloys.

Table 4 below shows relative fractions of twins, grain areas, and phase weight percent fractions of the Mn—Al—Ti alloys determined via EBSD. Phase weight percent fractions do not sum to 100% due to a small number of unindexable patterns.

TABLE 4

| EBSD Property | Mn₅₄Al₄₆ | Mn₅₃Al₄₆Ti₁ | Mn₅₄Al₄₅Ti₁ |
|---|---|---|---|
| True Twin | 0.27 ± 0.02 | 0.45 ± 0.07 | 0.65 ± 0.03 |
| Order Twin | 0.06 ± 0.01 | 0.09 ± 0.03 | 0.09 ± 0.02 |
| Pseudo Twin | 0.02 | 0.00 | 0.00 |
| Grain Area (μm²) | 29.4 | 65.3 | 97.3 |
| Equivalent circle | 6.1 | 9.1 | 11.1 |
| grain diameter (μm) | | | |
| τ phase wt. % | 97.8 ± 3.0 | 93.8 ± 0.7 | 98.4 ± 0.6 |
| γ₂ phase wt. % | 0 ± 0 | 2.7 ± 0.6 | 0.1 ± 0.05 |

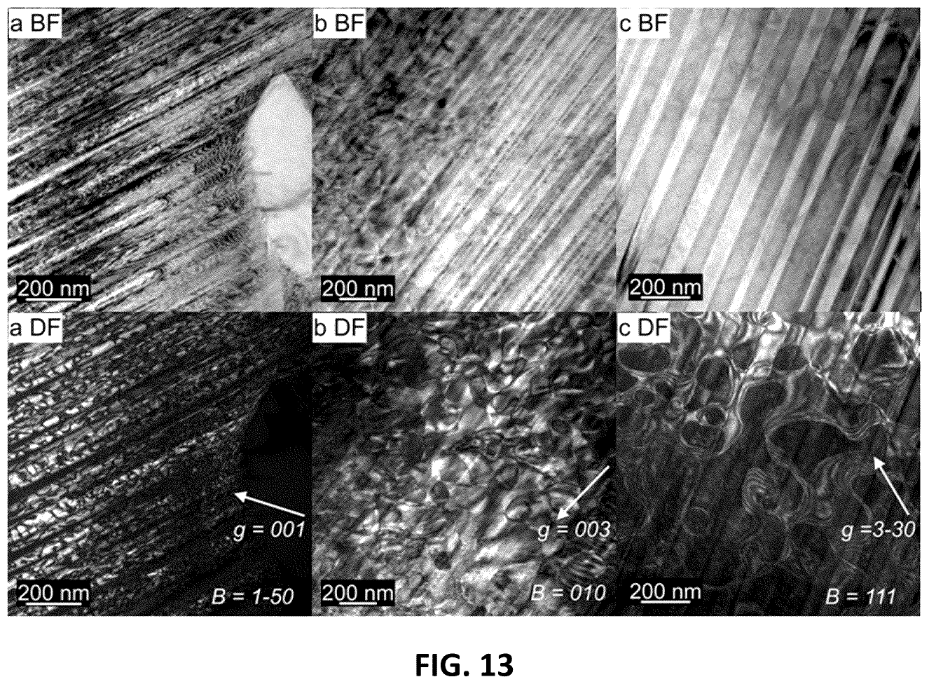

To further understand the true impact of twins on the magnetic properties and to characterize the APB density in the three alloys to determine if titanium had a clear effect of APB density, TEM was performed to characterize the APB density as illustrated in FIG. 13. Bright-field (BF, upper row of panels in FIG. 13) and centered dark-field (CDF, lower row of panels in FIG. 13) using a selective area diffraction (SAD) aperture were used to image APBs present in the samples. The invisibility criterion for a crystal defect in TEM is met when α, the phase factor, is equal to 2πn, where n is an integer. Given a diffraction vector, \vec{g} and a defect fault vector, \vec{R}, the invisibility criterion is met when α=2π\vec{g}*\vec{R}=2πn. Because APBs in Mn—Al have the fault vector,

$$\vec{R} = \pm \frac{1}{2} < 101 > ,$$

they will all therefore be visible in CDF using any superlattice spot and invisible when using a fundamental spot.

The APB density was observed to be significantly decreased in the samples with 1 at. % Ti as shown by the APBs visible in the DF images. In fact, the trend in Mᵣ from lower to higher between Mn₅₄Al₄₆, Mn₅₃Al₄₆Ti₁, and Mn₅₄Al₄₅Ti₁ matches the trend of decreasing APB density. APBs were only found in twinned grains in the three alloys, and the twins are visible as long striated bands in the BF images. It is possible that they were present in non-twinned grains but a thorough search did not observe any APBs outside of twinned regions, which are visible as the long striations behind APBs in the TEM figures.

Given that the number of twinned grains in the samples with 1 at. % Ti addition was far greater than without Ti, it could be expected that overall, more APBs would be present in the Ti-alloyed samples—assuming that APBs are indeed only found in the presence of twins. Thus, magnetic performance should suffer. However, once again, recall from DFT that Ti is expected to segregate to the APB and clearly lowers APB density within twinned grains. Because Mᵣ and H_{ci} were improved with the Ti addition, this implies that the positive benefits of Ti addition on the APB outweigh any negative impacts from increasing twin density. Recall that the negative aspects of APBs are derived from their behavior as AFM-coupled defects and as reverse domain nucleation sites.

In the first case, where APBs are AFM-coupled defects, the addition of Ti may indeed flip the APB configuration from AFM to FM. Thus, the presence of APBs becomes less detrimental because they can contribute to FM behavior. Therefore, because APBs are still present in the Mn—Al—Ti alloys yet cause less AFM behavior in the VSM and thermal VSM data, it is likely that a significant fraction of the APBs take on an FM coupling across the interface in the presence of Ti.

In the second case, by lowering the density of APBs, the density of reversal nucleation sites is lowered. This is significant, because the farther apart nucleation sites are spread, the larger the reversing domains must grow to reverse the entire volume. If the domains must grow larger between nucleation sites, then they are more likely to encounter defects, like dislocations, stacking faults, and twins, all of which can pin the domain walls to slow reversal and improve H_{ci}. Referencing the few studies that have observed both APBs and twins in Mn—Al, the same conclusion can be drawn: twins are more likely to act as pinning sites and APBs are more likely to act as nucleation sites for reversing domains.

The APB density was observed to be significantly decreased in the samples with 1 at. % Ti, as shown in FIG. 13. In fact, the trend in Mᵣ shown in Table 1 from lower to higher between Mn₅₄Al₄₆, Mn₅₃Al₄₆Ti₁, and Mn₅₄Al₄₅Ti₁ matches the trend of decreasing APB density. APBs were only found in twinned grains herein. It is possible that they were present in non-twinned grains but a thorough search did not observe any APBs outside of twinned regions, which are visible as long striations behind APBs in the TEM BF images.

Given that the number of twinned grains in the samples with 1 at. % Ti addition was far greater than without Ti, it might be expected that overall, more APBs would be present in the Ti-alloyed samples—assuming that APBs are indeed only found in the presence of twins. Thus, magnetic performance should suffer. However, once again, recall from DFT that Ti segregate to the APB and clearly lowers APB density within twinned grains. Because Mᵣ and H_{ci} were improved with the Ti addition, this implies that the positive benefits of Ti addition on the APB outweigh any negative impacts from increasing twin density. Recall that the negative aspects of APBs are derived from their behavior as AFM-coupled defects and as reverse domain nucleation sites.

In the first case, where APBs are AFM-coupled defects, the addition of Ti may indeed flip the APB configuration from AFM to FM. Thus, the presence of APBs becomes less detrimental because they can contribute to FM behavior. Therefore, because APBs are still present in the Mn—Al—Ti alloys yet cause less AFM behavior in the VSM and thermal VSM data, it is likely that a significant fraction of the APBs take on an FM coupling across the interface in the presence of Ti.

In the second case, by lowering the density of APBs, the density of reversal nucleation sites is lowered. This is significant, because the farther apart nucleation sites are spread, the larger the reversing domains must grow to reverse the entire volume. If the domains must grow larger between nucleation sites, then they are more likely to encounter defects, like dislocations, stacking faults, and twins, all of which can pin the domain walls to slow reversal and improve H_{ci}.

The secondary impacts of adding 1 at. % Ti is an increased density of true twins (76° misorientation) and increased presence of secondary phases γ₂ and β. Previous theories suggest that these factors should act to diminish H_{ci} and Mᵣ. However, while the negative effects of secondary phases are well established, the effects of twins are less well established. The highly-twinned microstructure is clearly visible when comparing the alloys with and without 1 at. % Ti addition. While the twinned grains are distributed homogeneously throughout the Mn—Al—Ti alloys, only a few large grains containing a high density of twins are visible in FIG. 12A, surrounded by a majority of small randomly-oriented grains which contain a low density of twins. By contrast, the Mn—Al—Ti samples in FIGS. 12B and 12C consist of larger grains intersected by a high density of twins and very few small individual grains. Because neither H_{ci} nor Mᵣ were diminished in the VSM data, the high density of twins does not appear to negatively affect these properties in Mn—Al—Ti alloys.

### Phase Transformation Properties

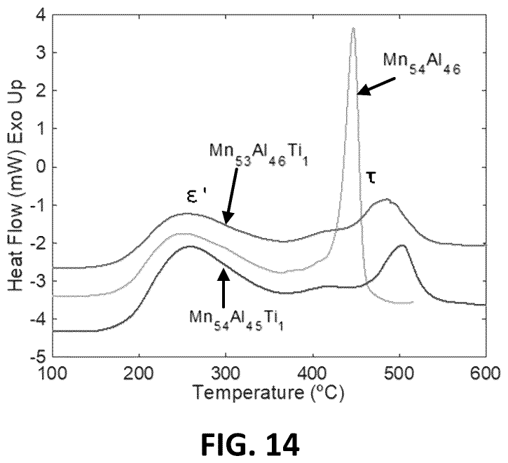

The reasons why 1 at. % Ti addition significantly increases the density of twins may be found in the phase transformation behavior from ε to τ. DSC measurements are shown in FIG. 14 and Table 5 (below, showing the phase transformation peak temperatures, activation energy, and enthalpy calculated for the Mn—Al—Ti alloys from DSC measurements) of quenched ε phase samples heated at a constant rate to transform to the τ phase. The peak of the ε′ phase ordering transformation was changed by <10° C. with the addition of Ti. However, the peak of the hybrid transformation to t phase was increased by 39° C. in Mn₅₃Al₄₆Ti₁ and increased by 56° C. in Mn₅₄Al₄₅Ti₁. The Mn—Al—Ti alloys also had a lower calculated activation energy to transform to the ε phase, but a higher activation energy to transform to the τ phase.

The activation energy values in Table 5, below, demonstrate that the addition of 1 at. % Ti lowers the activation energy, Eₐ, barrier for ε′ phase ordering and raises the activation energy barrier to transform to the τ phase compared to the base alloy. This is significant because the ordering of ε to ε′ is a prerequisite for the displacive mode of the hybrid displacive-diffusional transformation to τ. The ε phase ordering into ε′ is visible as a low temperature exotherm in FIG. 14, in agreement with previous results of others. The ordering is followed by displacive shearing to τ that has been shown to result in twinning of the resulting τ phase as a method of stress relaxation. The resulting morphology of this transformation mode is characterized by a plate-like τ phase with a high density of twins and stacking faults. This is in contrast to the diffusional mode, which generally dominates at higher temperatures (>450° C.) and follows a compositionally-invariant massive mode of transformation. While twins have been reported in τ phase grains transformed at higher temperatures where the diffusional massive mechanism dominates, they are not a required feature of the transformation to the same extent as the martensitic displacive mode. To confirm this, a sample of Mn₅₄Al₄₆ ε phase was annealed at 350° C. for 13 h to transform it to τ phase. This temperature was chosen because it is above the temperature of ordering to ε′ phase but below the peak transformation temperature to τ phase. After transforming to τ phase the relative twin density was calculated by EBSD to be 0.35, directly between Mn₅₄Al₄₆ heat treated at 450° C. (0.27) and Mn₅₃Al₄₆Ti₁ heat treated at 550° C. (0.45). Therefore Mn—Al samples transformed in the region where the displacive mode is dominant have a higher twin density, as expected.

Because such a high twin density was observed with Ti addition, it follows that the lowering of the Eₐ barrier for ε′ ordering favors the displacive phase transformation pathway, even at 550° C. The peak of the τ phase transformation was also increased ˜40-50° C. with 1 at. % Ti addition. This is an expected result of the increase in Eₐ for the transformation to τ phase. The overall narrative displayed by this data suggests that the diffusional mode of the transformation from ε to τ is indeed inhibited relative to the displacive mode by the addition of 1 at. % Ti and this, consequently, increases the twin density. More to this point, a small exotherm is visible in FIG. 14 in the 1 at. % Ti alloys near 400° C., followed by a larger exotherm near 500° C. In Mn₅₄Al₄₆, both the displacive and diffusional transformation modes are active within one τ phase transformation peak near 450° C., whereas in the alloys with 1 at. % Ti the peaks appear to be split into two. This further suggests that the massive diffusional mode is shifted to higher temperatures as a result of adding 1 at. % Ti.

Table 5, below, provides the phase transformation onset temperatures, activation energy, and enthalpy calculated for the Mn—Al—Ti alloys from DSC measurements.

TABLE 5

| Property | Mn₅₄Al₄₆ | Mn₅₃Al₄₆Ti₁ | Mn₅₄Al₄₅Ti₁ |
|---|---|---|---|
| ε′ phase onset ° C. | 252 | 256 | 259 |
| (10° C./min) | | | |
| τ phase onset ° C. | 447 | 486 | 503 |
| (10° C./min) | | | |
| ε′ Eₐ kJ/mol (f.u.*) | 142 ± 13 | 112 ± 8 | 81 ± 9 |
| ε′ ΔH J/g | 44 ± 8 | 31 ± 6 | 32 ± 7 |
| τ Eₐ kJ/mol (f.u.*) | 155 ± 8 | 168 ± 13 | 196 ± 19 |
| τ ΔH J/g | 40 ± 6 | 28 ± 7 | 27 ± 6 |

Note for the (*) notations in Table 5 above, that the g/mol of the different formula units for the three compositions are all within 0.5% and do not affect the Eₐ values by more than the significant figures given.

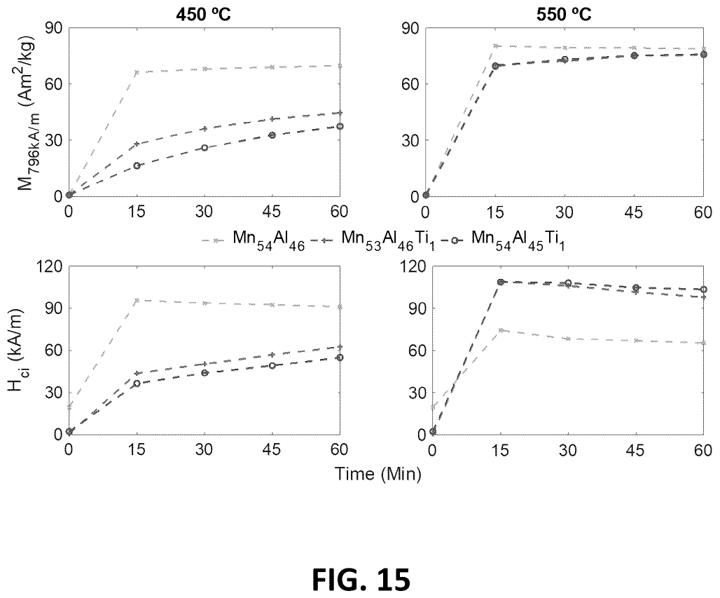

FIG. 15 shows the results of annealing the three alloys at 450° C. and 550° C. from the ε phase to the τ phase. In good agreement with the DSC results, the ε phase Mn₅₄Al₄₆ alloy readily transformed to the τ phase at 450° C. with optimum properties at 30 minutes. Likewise, the Mn—Al—Ti alloys had a slower transformation to the τ phase and required a 550° C. heat treatment for 60 minutes to achieve the same mix of high magnetization (indicative of the τ phase fraction) with high coercivity achieved for Mn₅₄Al₄₆ at 450° C. Optimized magnetic properties were chosen to best compare the three alloys at similar levels of transformed τ phase, defect density, and grain size and minimize extrinsic variables. Although it would have been ideal, it was not possible to perform the same heat treatment on all three alloys without under-transforming the Ti alloys or over-coarsening the Mn—Al alloy.

The most notable change in the phase transformation behavior with the addition of 1 at. % Ti is the increase of the t phase transformation peak by 39-56° C. in FIG. 14. Furthermore, the activation energy values demonstrate that the addition of 1 at. % Ti lowers the activation energy, Eₐ, barrier for ε′ phase ordering and raises the activation energy barrier to transform to the τ phase compared to the base alloy. This is a significant intrinsic effect, because the ordering of ε to ε′ is a prerequisite for the displacive mode of the hybrid displacive-diffusional transformation to τ. The ε phase ordering into ε′ is visible as a low temperature exotherm in FIG. 14. The ordering is followed by displacive shearing to τ that has been shown to result in twinning of the resulting τ phase as a method of stress relaxation. The resulting morphology of this transformation mode is characterized by a plate-like τ phase with a high density of twins and stacking faults. This is in contrast to the diffusional mode, which generally dominates at higher temperatures (>450° C.) and follows a compositionally-invariant massive mode of transformation. While twins have been reported in τ phase grains transformed at higher temperatures where the diffusional massive mechanism dominates, they are not a required feature of the transformation to the same extent as the martensitic displacive mode. To corroborate this, a sample of Mn₅₄Al₄₆ τ phase was annealed at 350° C. for 13 hours to transform it to the τ phase. This temperature is above the temperature of ordering to ε′ phase but below the peak transformation temperature to τ phase. After transforming to the τ phase, the relative true twin density was calculated by EBSD to be 0.35, greater than Mn₅₄Al₄₆ heat treated at 450° C. for 30 min (0.27). Therefore Mn—Al samples transformed at a temperature where the displacive mode is more dominant have a higher twin density.

Because such a high true twin density was observed with Ti addition, and the source of twinning is as a byproduct of the phase transformation to the τ phase, it follows that the lowering of the Eₐ barrier for ε′ ordering favors the displacive phase transformation pathway, even at 550° C. The peak of the τ phase transformation was also increased ˜40-50° C. with 1 at. % Ti addition. This increase in Eₐ follows from the transformation to τ phase. The overall narrative displayed by this data suggests that the diffusional mode of the transformation from ε to τ is indeed inhibited relative to the displacive mode by the addition of 1 at. % Ti and this, consequently, increases the twin density. More to this point, a small exotherm is visible in the 1 at. % Ti alloys near 400° C., followed by a larger exotherm near 500° C. In Mn₅₄Al₄₆, both the displacive and diffusional transformation modes are active within one τ phase transformation peak near 450° C., whereas in the alloys with 1 at. % Ti the peaks appear to be split into two, one for each of the two transformation modes. This further suggests that the massive diffusional mode is shifted to higher temperatures as a result of adding 1 at. % Ti.

The implications of raising the phase transformation peak temperature for the τ phase with 1 at. % Ti addition is that the transformation can be performed at higher temperature for longer time periods. This opens up the processing window for conventional techniques such as sintering, meaning that the sintering step could conceivably be combined with the phase transformation to τ phase, simplifying manufacturing.

### Thermal Stability

To better understand the data in FIG. 11, the thermal coefficients of Mᵣ and H_{ci} were calculated using a linear least-squares best-fit for each alloy. Mᵣ coefficients of −0.10%/° C., −0.13%/° C., and −0.14%/° C. were measured for Mn₅₄Al₄₆, Mn₅₄Al₄₅Ti₁, and Mn₅₃Al₄₆Ti₁, respectively. The Mᵣ coefficient for Sm—Co is ˜−0.035%/° C. and for Nd—Fe—B is ˜−0.1%/° C. H_{ci} coefficients of −0.15%/° C.,−0.20%/° C., and −0.21%/° C. were measured for Mn₅₄Al₄₆, Mn₅₄Al₄₅Ti₁, and Mn₅₃Al₄₆Ti₁, respectively. These are all roughly one-third the negative thermal coefficient of H_{ci} for Nd—Fe—B (−0.6%/° C.), and as good if not slightly better than Sm—Co at −0.2%/° C. to −0.31%/° C., depending on the composition. This is important because due to these trends, (BH)ₘₐₓ for Nd—Fe—B PMs drops off sharply at elevated temperatures, losing ˜80% of room temperature performance at 200° C., which limits its performance range. By contrast, 49%, 32%, and 36% of room temperature (BH)ₘₐₓ was maintained at 200° C. for Mn₅₄Al₄₆, Mn₅₄Al₄₅Ti₁, and Mn₅₃Al₄₆Ti₁, respectively.

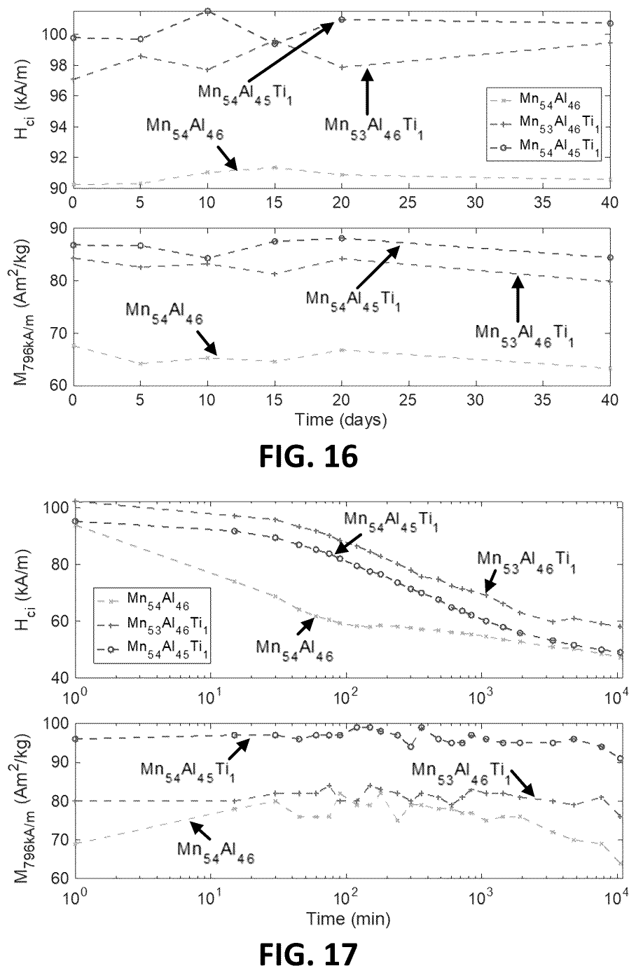

Given the significant changes in phase transformation thermodynamics and kinetics observed via DSC, stability studies were performed to determine if the addition of 1 at. % of Ti improved the thermal stability of the τ phase. The as-transformed τ phase samples of each composition were held at 250° C. for up 40 days and held at 550° C. for up to 176 h (˜1 week). Samples were tested in the same orientation to the applied field in the VSM but not demagnetization corrected. The magnetic properties of the τ phase in the three alloys were generally stable even up to 40 days at 250° C., as shown in FIG. 16. The change in M_{796kA/m} from 0 days to 40 days was −6.4%, −5.3%, and −2.8% for Mn₅₄Al₄₆, Mn₅₃Al₄₆Ti₁, and Mn₅₄Al₄₅Ti₁ respectively. The same alloys showed a small increase in H_{ci} after 40 days of 0.4%, 2.5%, and 1.0%. The loss of M_{796kA/m} and gain in H_{ci} is the expected trend for Mn—Al at this temperature based on the metastable nature of the τ phase. The slight loss of M_{796kA/m} in each alloy is most likely due to phase decomposition of the τ phase into the equilibrium γ₂ and β phases. Since these two phases are effective pinning sites to domain wall motion, as they increase in volume there is an associated increase in H_{ci}. Given that the alloys with 1 at. % Ti showed a smaller loss of M_{796kA/m} than Mn₅₄Al₄₆, the addition of Ti does not appear to destabilize the τ phase and instead is shown to increase phase stability at 250° C.

More insight into this is shown in the samples annealed at 550° C. for up to 1 week from FIG. 17, which shows the evolution of those properties when held at 550° C. At this higher temperature, the differences between the 1 at. % Ti alloys and the base alloy become more apparent. First, the drop in H_{ci} from 1 min to 15 min in Mn₅₄Al₄₆ was dramatic, losing 21% compared to the Mn—Al—Ti alloys at ˜5%. Only after 120 min did the slope of H_{ci} for Mn₅₄Al₄₆ level off. The Mn—Al—Ti alloys, by comparison, have a minimal drop in H_{ci} until 90 min, at which point their curves approach the same slope as the initial slope in Mn₅₄Al₄₆. Bearing in mind that the 1 at. % alloys had already been annealed for 1 h at 550° C., the addition of Ti significantly improved the stability of H_{ci} at 550° C. The M_{796kA/m} values were largely constant for the 1 at. % Ti alloys, dropping by only 18 5% from 1 min to 10⁴ min. There was some variation in the M_{796kA/m}, which was to be expected since this temperature is where the transformation to the τ phase occurs and additional ordering of the L1₀ structure is likely, which improves M_{796kA/m}. Taking the difference from the maximum M_{796kA/m} value to the value at 10⁴ min gave a drop of no more than 10% for both Mn₅₃Al₄₆Ti₁ and Mn₅₄Al₄₅Ti₁. By comparison, the drop in M_{796kA/m} for Mn₅₄Al₄₆ was more complex and dramatic. Despite being ˜98 wt. % τ phase by both XRD and EBSD measurements, M_{796kA/m} increased by 14% after 30 min. It then dropped from this maximum by 18% after 10⁴ min, with an overall drop from 1 min to 10⁴ min of 7%.

The addition of 1 at. % evidently improved the stability of H_{ci} and M_{796kA/m} at 550° C. but the mechanism is not obviously clear. The crystalline anisotropy contribution to H_{ci} is an intrinsic property of the τ phase and should not change when held at constant temperature. The microstructural contribution to H_{ci}, however, can change over time as the microstructure evolves. The Mn₅₄Al₄₆ sample had the highest APB density, smallest grain size, and lowest twin density, with roughly the same density of GNDs as with 1 at. % Ti. The samples with 1 at. % Ti had a much higher twin density and lower APB density. APBs and GNDs can move within grains at this temperature and could be annealed out over sufficiently long time spans. The loss of APBs and dislocations in favor of a well-ordered L1₀ structure explains the gain in M_{796kA/m} observed in the first 30 min at 550° C. However, the mutual annihilation of dislocations out of the Mn₅₄Al₄₆ sample is also an explanation for the dramatic loss of H_{ci}.

Given than dislocations are well documented as a primary mechanism for increasing H_{ci} in Mn—Al by domain wall pinning, one theory is that the addition of 1 at. % Ti inhibits dislocation motion. For instance, dislocations are impeded when they encounter other dislocations, solute atoms, precipitates, twins, and grain boundaries, as they all interact with the strain field of the dislocation. The addition of Ti as a solute atom therefore likely impeded dislocation motion, but the high density of nanoscale true twins was another useful mechanism to slow dislocation motion. The TEM images in FIG. 13 show twins of <100 nm across. In other alloys, nanotwins have been shown to be as effective as grain boundaries in strengthening via the Hall-Petch mechanism of impeding dislocation motion, but this mechanism has yet to be studied in Mn—Al. Thus, despite the generally smaller grain size of the Mn₅₄Al₄₆ alloy, the addition of 1 at. % Ti was shown to preserve H_{ci} at 550° C. for significantly longer, most likely by impeding dislocation motion with solute atoms and twins.

Improving the stability of M_{796kA/m} and H_{ci} at elevated temperatures is essential to manufacturing Mn—Al PMs with high (BH)ₘₐₓ. This is the reason for the common use of C as an interstitial alloyant in Mn—Al because it stabilizes the τ phase against decomposition without significantly diminishing the magnetic performance. The conventional processing route for permanent magnets of powder milling, magnetic aligning, and sintering into a bulk shape cannot be optimized if the magnetic properties achieved after milling are lost during sintering. Therefore, the addition of 1 at. % Ti widens the temperature and time window in which sintering can be performed, opening the door for new processing routes.

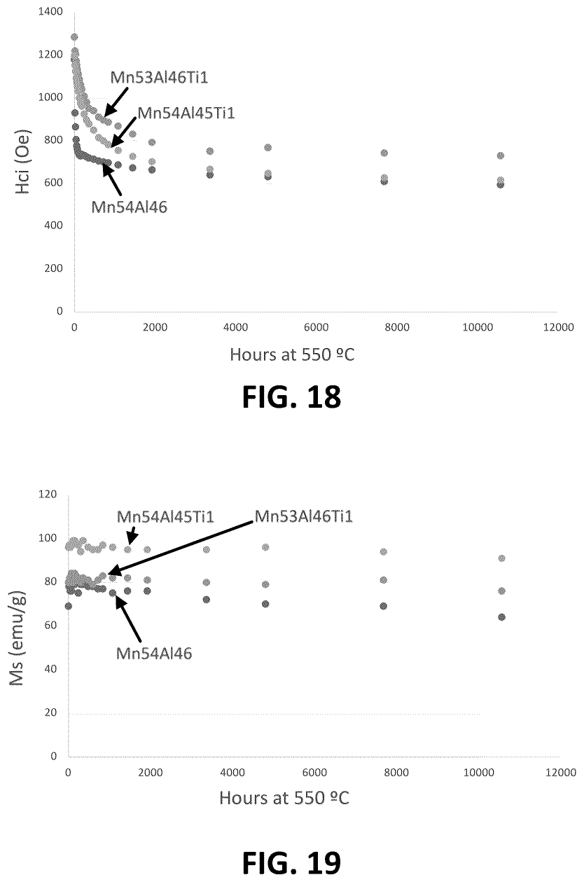

Stability of magnetic properties over time are illustrated in FIGS. 18 and 19. FIG. 18 illustrates improved stability of coercivity at high temperatures (at 550° C. for indicated duration of hours) which enables higher temperature sintering for longer durations. FIG. 19 illustrates low field magnetization (M_{1T}) is improved above the base alloy over long durations at 550° C. In both figures it can be seen that, while magnetic properties do slightly degrade over time at temperature, that the stable performance over time of the specimen with titanium additions continues to outperform the titanium-less base alloy and does not completely degrade to the level of performance of the titanium-less base alloy.

Disclosed above, the addition of 1 at. % Ti as a ternary element to Mn—Al was shown to improve magnetic performance and thermal stability compared to a Mn₅₄Al₄₆ reference alloy. Ab-initio calculations demonstrated that Ti segregates to APB defects in the FM τ phase and motivates FM coupling across the APB compared to AFM coupling in the reference case. This is significant because APBs are a byproduct of the displacive-diffusional phase transformation from the ε phase to the τ phase. APBs result in AFM-coupling between Mn atoms across the boundary. Such AFM behavior was observed in the VSM data for the Mn—Al alloy but not for the Mn—Al—Ti alloys. TEM showed that the addition of Ti lowered APB density when substituted for Al or for Mn in Mn₅₄Al₄₆. The frequency of true twin defects increased with 1 at. % Ti addition, but the only negative effect was a small loss of Mₛ. Order twin density was low and relatively unchanged by the Ti addition. The increase in twin density was attributed partially to changes in the hybrid displacive-diffusional phase transformation, suggesting that the addition of ₁ at. % Ti favors the displacive mode. In part by suppressing APBs, Mᵣ and H_{ci} were improved in the Mn—Al—Ti alloys despite the high density of true twins. Notably, APBs were only observed within twinned regions, indicating that the presence of twins in Mn—Al is usually accompanied by APBs. Therefore, the twins themselves may not be the source of negative magnetic effects observed in previous studies. Rather, APBs within the twinned regions may be the primary contributor to loss of Mᵣ and H_{ci} in the τ phase, and have been overlooked as a root cause. The Mn—Al—Ti alloys had significantly better stability of H_{ci} and M_{796kA/m} when held at 550° C., showing that the addition of 1 at. % Ti improves t phase stability and slows the loss of microstructural defects that improve H_{ci}.

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment”, “in another embodiment”, “in an embodiment”, or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another.

Although the invention has been described in considerable detail with reference to certain embodiments, one skilled in the art will appreciate that the present invention can be used in alternative embodiments to those described, which have been presented for purposes of illustration and not of limitation. Therefore, the scope of the appended claims should not be limited to the description of the embodiments contained herein.

What is claimed is:

1. A Mn—Al—Ti permanent magnet comprising:
a body composed of an alloy consisting essentially of manganese in an amount of 50 to 56 atomic percent of the alloy, aluminum in an amount of 44 to 50 atomic percent of the alloy, and titanium in an amount of 0.5 to 1.5 atomic percent of the alloy with a total amount of manganese, aluminum and titanium not exceeding 100 atomic percent.

2. The Mn—Al—Ti permanent magnet of claim 1, wherein the alloy is a ternary alloy consisting of manganese in an amount of 50 to 56 atomic percent, aluminum in an amount of 44 to 50 atomic percent, and titanium in an amount of 0.5 to 1.5 atomic percent.

3. The Mn—Al—Ti permanent magnet of claim 1, wherein, in the alloy, the amount of manganese is between 53 and 55 atomic percent of the alloy, the amount of aluminum is between 44 and 46 atomic percent of the alloy, and the amount of titanium is between 0.5 to 1.5 atomic percent of the alloy.

4. The Mn—Al—Ti permanent magnet of claim 1, wherein in the alloy the amount of manganese is 54 atomic percent of the alloy, the amount of aluminum is 45 atomic percent of the alloy, and the amount of titanium is 1 atomic percent of the alloy with substantially no other elements present in the alloy.

5. The Mn—Al—Ti permanent magnet of claim 4, wherein the Mn—Al—Ti permanent magnet consisting essentially of manganese, aluminum, and titanium has a (BH)ₘₐₓ exceeding 33% of a titanium-less Mn—Al permanent magnet having 54 atomic percent manganese and 46 atomic percent aluminum.

6. The Mn—Al—Ti permanent magnet of claim 1, wherein in the alloy the amount of manganese is 53 atomic percent of the alloy, the amount of aluminum is 46 atomic percent of the alloy, and the amount of titanium is 1 atomic percent of the alloy with substantially no other elements present in the alloy.

7. The Mn—Al—Ti permanent magnet of claim 1, wherein the amount of titanium is between 0.75 to 1.25 atomic percent of the alloy.

8. The Mn—Al—Ti permanent magnet of claim 1, wherein the titanium preferentially sits on anti-phase boundaries (APBs) of the microstructure, resulting in ferromagnetic coupling across the APBs, thereby suppressing negative effects usually associated with APBs in a titanium-less Mn—Al permanent magnet and improving remanence of the Mn—Al—Ti permanent magnet.

9. The Mn—Al—Ti permanent magnet of claim 1, wherein the titanium stabilizes a coercivity of the Mn—Al—Ti permanent magnet at elevated temperatures in excess of 550° C. in comparison to a titanium-less Mn—Al permanent magnet with Mn to Al ratios to that of the Mn—Al—Ti permanent magnet.

10. The Mn—Al—Ti permanent magnet of claim 1, wherein the addition of titanium relative to a titanium-less Mn—Al permanent magnet with Mn to Al ratios to that of the Mn—Al—Ti permanent magnet stabilizes the τ/ε phase to allow processing of the Mn—Al—Ti permanent magnet at elevated temperatures and stabilizing coercivity.

11. The Mn—Al—Ti permanent magnet of claim 1, wherein, regardless of direction of measurement, Mᵣ, H_{ci}, and (BH)ₘₐₓ are greater in the Mn—Al—Ti permanent magnet in comparison to a titanium-less Mn—Al permanent magnet with Mn to Al ratios of the Mn—Al—Ti permanent magnet.

12. The Mn—Al—Ti permanent magnet of claim 1, wherein, in comparison to a titanium-less Mn—Al permanent magnet with Mn to Al ratios of the Mn—Al—Ti permanent magnet, the Mn—Al—Ti permanent magnet has a decreased density of anti-phase boundaries and an increased anti-phase boundary domain size resulting in less antiferromagnetic coupling and fewer magnetic domain reversal sites.

13. A method of making a Mn—Al—Ti permanent magnet comprising:
forming an alloy consisting essentially of manganese in an amount of 50 to 56 atomic percent of the alloy, aluminum in an amount of 44 to 50 atomic percent of the alloy, and titanium in an amount of 0.5 to 1.5 atomic percent of the alloy with a total amount of manganese, aluminum and titanium not exceeding 100 atomic percent into a body of a Mn—Al—Ti permanent magnet.

14. The method of making the Mn—Al—Ti permanent magnet of claim 13, wherein the step of forming the alloy into the body of a Mn—Al—Ti permanent magnet occurs as part of a casting operation in which the manganese, aluminum, and titanium are melted and then cast.

15. The method of making the Mn—Al—Ti permanent magnet of claim 13, wherein the step of forming the alloy into the body of a Mn—Al—Ti permanent magnet comprises sintering powder metal containing the manganese, aluminum, and titanium.
